(19) United States
(12) Patent Application Publication
(10) Pub. No.: US 2025/0253926 A1
(43) Pub. Date: Aug. 7, 2025

(54) SPATIAL DOMAIN PRECODERS FOR SERVING CELLS

(71) Applicant: QUALCOMM Incorporated, San Diego, CA (US)

(72) Inventors: Qiaoyu LI, Beijing (CN); Mahmoud TAHERZADEH BOROUJENI, San Diego, CA (US); Tao LUO, San Diego, CA (US)

(21) Appl. No.: 18/841,281

(22) PCT Filed: May 4, 2022
(86) PCT No.: PCT/CN2022/090850

§ 371 Date: Aug. 23, 2024

(51) Int. Cl. H04B 7/06; H04L 41/16

(52) U.S. Cl. CPC H04B 7/0697; H04B 7/06966; H04L 41/16

(57) ABSTRACT

This disclosure provides systems, methods and apparatus, including computer programs encoded on computer storage media, for spatial domain precoders for serving cells. A device may communicate with a network entity on multiple serving cells and may use spatial relation information associated with one serving cell to select a spatial domain precoder for transmissions on another serving cell. For example, the device may derive a spatial domain precoder for a transmission on a first serving cell using spatial relation information for receiving reference signals on a second serving cell. Additionally, or alternatively, the device may calculate a spatial domain precoder for a transmission on a first serving cell in response to monitoring a second serving cell for a downlink reference signal. Additionally, or alternatively, the device may select a spatial domain precoder for a transmission on a first serving cell based on uplink precoding information indicated for a second serving cell.

### CROSS REFERENCE

The present application is a 371 national phase filing of International PCT Application No. PCT/CN2022/090850 by LI et al., entitled “SPATIAL DOMAIN PRECODERS FOR SERVING CELLS,” filed May 4, 2022, which is assigned to the assignee hereof, and which is expressly incorporated by reference in its entirety herein.

### TECHNICAL FIELD

This disclosure relates to wireless communications, including spatial domain precoders for serving cells.

### DESCRIPTION OF THE RELATED TECHNOLOGY

Wireless communications systems are widely deployed to provide various types of communication content such as voice, video, packet data, messaging, broadcast, and so on. These systems may be capable of supporting communication with multiple users by sharing the available system resources (for example, time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations (BSs) or one or more network access nodes, each simultaneously supporting communication for multiple communication devices, which may be otherwise known as user equipment (UE).

### SUMMARY

The systems, methods and devices of this disclosure each have several innovative aspects, no single one of which is solely responsible for the desirable attributes disclosed herein.

One innovative aspect of the subject matter described in this disclosure can be implemented in a method for wireless communications at a device. The method may include receiving a control message indicating a sounding reference signal (SRS) resource on a first serving cell and spatial relation information for the SRS resource, where the spatial relation information associates the SRS resource with a downlink reference signal on a second serving cell, selecting a first spatial domain precoder for transmitting an SRS according to a second spatial domain precoder associated with the downlink reference signal on the second serving cell, and transmitting the SRS via the SRS resource on the first serving cell using the first spatial domain precoder.

Another innovative aspect of the subject matter described in this disclosure can be implemented in an apparatus for wireless communications at a device. The apparatus may include an interface and a processing system. The interface may be configured to obtain a control message indicating an SRS resource on a first serving cell and spatial relation information for the SRS resource, where the spatial relation information associates the SRS resource with a downlink reference signal on a second serving cell, the processing system may be configured to select a first spatial domain precoder for transmitting an SRS according to a second spatial domain precoder associated with the downlink reference signal on the second serving cell, and the interface may be further configured to output the SRS for transmission via the SRS resource on the first serving cell using the first spatial domain precoder.

Another innovative aspect of the subject matter described in this disclosure can be implemented in an apparatus for wireless communications at a device. The apparatus may include a processor, memory coupled with the processor, and instructions stored in the memory. The instructions may be executable by the processor to cause the apparatus to receive a control message indicating an SRS resource on a first serving cell and spatial relation information for the SRS resource, where the spatial relation information associates the SRS resource with a downlink reference signal on a second serving cell, select a first spatial domain precoder for transmitting an SRS according to a second spatial domain precoder associated with the downlink reference signal on the second serving cell, and transmit the SRS via the SRS resource on the first serving cell using the first spatial domain precoder.

Another innovative aspect of the subject matter described in this disclosure can be implemented in another apparatus for wireless communications at a device. The apparatus may include means for receiving a control message indicating an SRS resource on a first serving cell and spatial relation information for the SRS resource, where the spatial relation information associates the SRS resource with a downlink reference signal on a second serving cell, means for selecting a first spatial domain precoder for transmitting an SRS according to a second spatial domain precoder associated with the downlink reference signal on the second serving cell, and means for transmitting the SRS via the SRS resource on the first serving cell using the first spatial domain precoder.

Another innovative aspect of the subject matter described in this disclosure can be implemented in a non-transitory computer-readable medium storing code for wireless communications at a device. The code may include instructions executable by a processor to receive a control message indicating an SRS resource on a first serving cell and spatial relation information for the SRS resource, where the spatial relation information associates the SRS resource with a downlink reference signal on a second serving cell, select a first spatial domain precoder for transmitting an SRS according to a second spatial domain precoder associated with the downlink reference signal on the second serving cell, and transmit the SRS via the SRS resource on the first serving cell using the first spatial domain precoder.

Another innovative aspect of the subject matter described in this disclosure can be implemented in a method for wireless communications at a device. The method may include receiving a control message indicating a configuration of an SRS resource set for transmitting an SRS on a first serving cell and indicating spatial relation information associating the SRS resource set with a downlink reference signal on a second serving cell, monitoring the second serving cell for the downlink reference signal according to the spatial relation information, selecting a spatial domain precoder for transmitting the SRS over the SRS resource set on the first serving cell according to the control message and the monitoring, and transmitting the SRS over the SRS resource set on the first serving cell using the selected spatial domain precoder.

Another innovative aspect of the subject matter described in this disclosure can be implemented in an apparatus for wireless communications at a device. The apparatus may include an interface and a processing system. The interface may be configured to obtain a control message indicating a configuration of an SRS resource set for transmitting an SRS on a first serving cell and indicating spatial relation information associating the SRS resource set with a downlink reference signal on a second serving cell; the processing system may be configured to monitor the second serving cell for the downlink reference signal according to the spatial relation information, and select a spatial domain precoder for transmitting the SRS over the SRS resource set on the first serving cell according to the control message and the monitoring; and the interface may be further configured to output the SRS for transmission over the SRS resource set on the first serving cell using the selected spatial domain precoder.

Another innovative aspect of the subject matter described in this disclosure can be implemented in an apparatus for wireless communications at a device. The apparatus may include a processor, memory coupled with the processor, and instructions stored in the memory. The instructions may be executable by the processor to cause the apparatus to receive a control message indicating a configuration of an SRS resource set for transmitting an SRS on a first serving cell and indicating spatial relation information associating the SRS resource set with a downlink reference signal on a second serving cell, monitor the second serving cell for the downlink reference signal according to the spatial relation information, select a spatial domain precoder for transmitting the SRS over the SRS resource set on the first serving cell according to the control message and the monitoring, and transmit the SRS over the SRS resource set on the first serving cell using the selected spatial domain precoder.

Another innovative aspect of the subject matter described in this disclosure can be implemented in another apparatus for wireless communications at a device. The apparatus may include means for receiving a control message indicating a configuration of an SRS resource set for transmitting an SRS on a first serving cell and indicating spatial relation information associating the SRS resource set with a downlink reference signal on a second serving cell, means for monitoring the second serving cell for the downlink reference signal according to the spatial relation information, means for selecting a spatial domain precoder for transmitting the SRS over the SRS resource set on the first serving cell according to the control message and the monitoring, and means for transmitting the SRS over the SRS resource set on the first serving cell using the selected spatial domain precoder.

Another innovative aspect of the subject matter described in this disclosure can be implemented in a non-transitory computer-readable medium storing code for wireless communications at a device. The code may include instructions executable by a processor to receive a control message indicating a configuration of an SRS resource set for transmitting an SRS on a first serving cell and indicating spatial relation information associating the SRS resource set with a downlink reference signal on a second serving cell, monitor the second serving cell for the downlink reference signal according to the spatial relation information, select a spatial domain precoder for transmitting the SRS over the SRS resource set on the first serving cell according to the control message and the monitoring, and transmit the SRS over the SRS resource set on the first serving cell using the selected spatial domain precoder.

Another innovative aspect of the subject matter described in this disclosure can be implemented in a method for wireless communications at a device. The method may include receiving an indication of a grant for transmitting uplink data on a first serving cell and uplink precoding information associated with an SRS resource set of a second serving cell, selecting a spatial domain precoder associated with the second serving cell based on the uplink precoding information received in the indication of the grant and associated with the SRS resource set of the second serving cell, and transmitting the uplink data on the first serving cell according to the grant and using the selected spatial domain precoder.

Another innovative aspect of the subject matter described in this disclosure can be implemented in an apparatus for wireless communications at a device. The apparatus may include an interface and a processing system. The interface may be configured to obtain an indication of a grant for transmitting uplink data on a first serving cell and uplink precoding information associated with an SRS resource set of a second serving cell, the processing system may be configured to select a spatial domain precoder associated with the second serving cell based on the uplink precoding information obtained in the indication of the grant and associated with the SRS resource set of the second serving cell, and the interface may be further configured to output the uplink data for transmission on the first serving cell according to the grant and using the selected spatial domain precoder.

Another innovative aspect of the subject matter described in this disclosure can be implemented in an apparatus for wireless communications at a device. The apparatus may include a processor, memory coupled with the processor, and instructions stored in the memory. The instructions may be executable by the processor to cause the apparatus to receive an indication of a grant for transmitting uplink data on a first serving cell and uplink precoding information associated with an SRS resource set of a second serving cell, select a spatial domain precoder associated with the second serving cell based on the uplink precoding information received in the indication of the grant and associated with the SRS resource set of the second serving cell, and transmit the uplink data on the first serving cell according to the grant and using the selected spatial domain precoder.

Another innovative aspect of the subject matter described in this disclosure can be implemented in another apparatus for wireless communications at a device. The apparatus may include means for receiving an indication of a grant for transmitting uplink data on a first serving cell and uplink precoding information associated with an SRS resource set of a second serving cell, means for selecting a spatial domain precoder associated with the second serving cell based on the uplink precoding information received in the indication of the grant and associated with the SRS resource set of the second serving cell, and means for transmitting the uplink data on the first serving cell according to the grant and using the selected spatial domain precoder.

Another innovative aspect of the subject matter described in this disclosure can be implemented in a non-transitory computer-readable medium storing code for wireless communications at a device. The code may include instructions executable by a processor to receive an indication of a grant for transmitting uplink data on a first serving cell and uplink precoding information associated with an SRS resource set of a second serving cell, select a spatial domain precoder associated with the second serving cell based on the uplink precoding information received in the indication of the grant and associated with the SRS resource set of the second serving cell, and transmit the uplink data on the first serving cell according to the grant and using the selected spatial domain precoder.

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

### BRIEF DESCRIPTION OF THE DRAWINGS

FIG. 1 shows an example wireless communications system that supports spatial domain precoders for serving cells.

FIGS. 2-4 show example signaling diagrams that support spatial domain precoders for serving cells.

FIGS. 5-7 show example process flows that support spatial domain precoders for serving cells.

FIG. 8 shows a block diagram of an example device that supports spatial domain precoders for serving cells.

FIGS. 9-11 show flowcharts illustrating example methods that support spatial domain precoders for serving cells.

Like reference numbers and designations in the various drawings indicate like elements.

### DETAILED DESCRIPTION

The following description is directed to some implementations for the purposes of describing the innovative aspects of this disclosure. However, a person having ordinary skill in the art will readily recognize that the teachings herein can be applied in a multitude of different ways. The described implementations may be implemented in any device, system or network that is capable of transmitting and receiving radio frequency (RF) signals according to any of the Institute of Electrical and Electronics Engineers (IEEE) 16.11 standards, or any of the IEEE 802.11 standards, the Bluetooth® standard, code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1×EV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, or other known signals that are used to communicate within a wireless, cellular or internet of things (IoT) network, such as a system utilizing third generation (3G), fourth generation (4G) or fifth generation (5G), or further implementations thereof, technology.

In some wireless communications systems, a wireless device, such as a user equipment (UE), may apply a spatial domain precoder to transmissions on a serving cell (such as beamformed transmissions). In some implementations, the wireless device may select the spatial domain precoder for the transmissions on the serving cell in accordance with spatial relation information that corresponds to one or more other transmissions transmitted or received by the wireless device on that serving cell. For example, the wireless device may apply a spatial domain precoder to an uplink transmission (such as a sounding reference signal (SRS) transmission or an uplink data transmission) on a serving cell in accordance with spatial relation information associated with transmitting or receiving a reference signal on that serving cell.

In some wireless communications systems, the wireless device may communicate with a network entity via more than one serving cell. Here, the wireless device may rely on spatial relation information associated with each of the serving cells to select corresponding spatial domain precoders to apply to uplink transmissions on the respective serving cells. For example, the wireless device may rely on spatial relation information associated with a first serving cell (such as spatial relation information that is associated with transmitting or receiving reference signals on the first serving cell) to select a spatial domain precoder for uplink transmissions on the first serving cell. Additionally, the wireless device may rely on spatial relation information associated with a second serving cell (such as spatial relation information that is associated with transmitting or receiving reference signals on the second serving cell) to select a second spatial domain precoder for uplink transmissions on the second serving cell.

In some implementations of the present disclosure, the wireless device may instead rely on spatial relation information associated with one serving cell to select a spatial domain precoder for uplink transmissions on another serving cell. In some implementations, the wireless device may derive a spatial domain precoder for a transmission on a first serving cell using spatial relation information for transmitting or receiving reference signals on a second serving cell. For example, the wireless device may receive a control message indicating a resource for transmitting an SRS on the first serving cell. Here, the wireless device may additionally receive resource signaling indicating spatial relation information for the SRS resource that is associated with the second serving cell. In this example, the wireless device may derive (such as by using a machine learning (ML) function) the spatial domain precoder for transmitting the SRS on the first serving cell in accordance with the spatial relation information associated with the second serving cell. In some implementations, the ML function may correspond to a deep neural network (DNN), a convolutional neural network (CNN), a recurrent neural network (RNN), or other examples of ML functions. Here, the wireless device may input information received from a network entity (such as the spatial relation information associated with the second serving cell) to the ML function to obtain the spatial precoder for transmitting the SRS on the first serving cell.

Additionally, or alternatively, the wireless device may calculate the spatial relation information for a transmission on a first serving cell in response to monitoring a second serving cell for a downlink reference signal (such as a synchronization signal block (SSB) transmission or a channel state information-reference signal (CSI-RS)). For example, the wireless device may receive a control message indicating a configuration of an SRS resource set for transmitting an SRS on the first serving cell. Additionally, the wireless device may receive signaling indicating spatial relation information that associated the SRS resource set on the first serving cell with the downlink reference signal on the second serving cell. Here, the wireless device may select the spatial domain precoder for transmitting the SRS on the first serving cell in response to monitoring the second serving cell for the downlink reference signal.

Additionally, or alternatively, the wireless device may select a spatial domain precoder for a transmission on a first serving cell using uplink precoding information indicated for a second serving cell. For example, the wireless device may receive an uplink grant that indicates uplink precoding information associated with an SRS resource set of the second serving cell. That is, the wireless device may receive the uplink grant for a transmission on the first serving cell that additionally indicates an SRS resource indicator (SRI) for the second serving cell, a transmitted precoding matrix indicator (TPMI) for the second serving cell, or both. Here, the wireless device may transmit uplink data according to the uplink grant using a spatial domain precoder that is selected according to the uplink precoding information (such as the TPMI) associated with the SRS resource set of the second serving cell.

Particular implementations of the subject matter described in this disclosure can be implemented to realize one or more of the following potential advantages. For example, a power consumption of the wireless device may decrease in implementations where the wireless device relies on spatial relation information associated with one serving cell to select a spatial domain precoder for uplink transmissions on another serving cell. That is, the wireless device may perform fewer beam sweeping procedures as compared to a wireless device that relies on spatial relation information associated with each serving cell to select spatial domain precoders for the corresponding serving cell, thus decreasing a power consumption of the wireless device. Additionally, or alternatively, the wireless device may perform fewer alterations of receive and transmit beams (such as phase shift alterations), thus decreasing a power consumption of the wireless device. Additionally, a quality of coverage of the wireless device may improve. For example, the wireless device may rely on spatial relation information associated with a first serving cell that has better coverage than a second serving cell to select a spatial domain precoder for uplink transmissions on the second serving cell. In some implementations, the quality of the coverage of the wireless device may improve as compared to a wireless device that relies on spatial relation information associated with the second serving cell with comparatively worse coverage to select the spatial domain precoder for uplink transmissions on the second serving cell. Further, relying on spatial relation information associated with one serving cell to select a spatial domain precoder for uplink transmissions on another serving cell may additionally decrease a latency associated with communications of the wireless device (such as due to increased scheduling opportunities). For example, implementing digital beamforming at the wireless device may enable different beams (such as beams associated with different serving cells) to be transmitted and received simultaneously, thus decreasing the latency associated with communications at the wireless device. Additionally, by relying on spatial relation information associated with one serving cell to select a spatial domain precoder for uplink transmissions on another serving cell, the wireless device may experience fewer scheduling restrictions. For example, the wireless device may rely on spatial relation information associated with a serving cell associated with more beams (such as more beams that are frequency division multiplexed or code division multiplexed), which may decrease scheduling restrictions as compared to a serving cell associated with less beams.

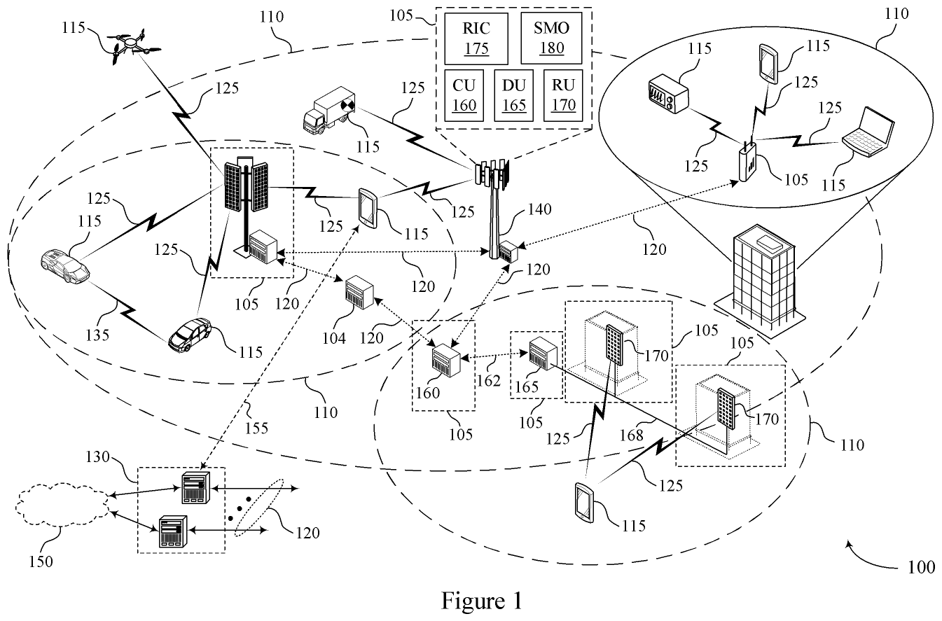

FIG. 1 shows an example wireless communications system 100 that supports spatial domain precoders for serving cells. The wireless communications system 100 may include one or more network entities 105, one or more UEs 115, and a core network 130. In some implementations, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In some implementations, network entities 105 and UEs 115 may wirelessly communicate via one or more communication links 125. For example, a network entity 105 may support a coverage area 110 (such as a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115 or network entities 105, as shown in FIG. 1.

As described herein, a node of the wireless communications system 100, which may be referred to as a network node, or a wireless node, may be a network entity 105 (such as any network entity described herein), a UE 115 (such as any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some implementations, network entities 105 may communicate with the core network 130, or with one another, or both. For example, network entities 105 may communicate with the core network 130 via one or more backhaul communication links 120 (such as in accordance with an S1, N2, N3, or other interface protocol). In some implementations, network entities 105 may communicate with one another over a backhaul communication link 120 (such as in accordance with an X2, Xn, or other interface protocol) either directly (such as directly between network entities 105) or indirectly (such as via a core network 130). In some implementations, network entities 105 may communicate with one another via a midhaul communication link 162 (such as in accordance with a midhaul interface protocol) or a fronthaul communication link 168 (such as in accordance with a fronthaul interface protocol), or any combination thereof. The backhaul communication links 120, midhaul communication links 162, or fronthaul communication links 168 may be or include one or more wired links (such as an electrical link, an optical fiber link), one or more wireless links (such as a radio link, a wireless optical link), among other examples or various combinations thereof. A UE 115 may communicate with the core network 130 through a communication link 155.

One or more of the network entities 105 described herein may include or may be referred to as a base station (BS) 140 (such as a base transceiver station, a radio BS, an access point, a radio transceiver, a NodeB, an eNodeB (eNB), a next-generation NodeB or a giga-NodeB (either of which may be referred to as a gNB), a next-generation eNB (ng-eNB), a Home NodeB, a Home eNodeB, or other suitable terminology). A network entity 105 (such as a BS 140) may be implemented in an aggregated or monolithic BS architecture, or alternatively, in a disaggregated BS architecture. For example, a network entity 105 may include one or more of a central unit (CU) 160, a distributed unit (DU) 165, a radio unit (RU) 170, a Radio Access Network (RAN) Intelligent Controller (RIC) 175 (such as a Near-Real Time RIC (Near-RT RIC), a Non-Real Time RIC (Non-RT RIC), a Service Management and Orchestration (SMO) 180 system, or any combination thereof. An RU 170 also may be referred to as a radio head, a smart radio head, a remote radio head (RRH), a remote radio unit (RRU), or a transmission/reception point (TRP). One or more components of the network entities 105 of a disaggregated RAN may be co-located, or one or more components of the network entities 105 may be located in distributed locations. A disaggregated RAN architecture may include or refer to an Open RAN (O-RAN) or Virtualized RAN (VRAN) architecture.

The split of functionality between a CU 160, a DU 165, and an RU 175 is flexible and may support different functionalities depending upon which functions (such as network layer functions, protocol layer functions, baseband functions, radio frequency functions, and any combinations thereof) are performed at a CU 160, a DU 165, or an RU 175. For example, a functional split of a protocol stack may be employed between a CU 160 and a DU 165 such that the CU 160 may support one or more layers of the protocol stack and the DU 165 may support one or more different layers of the protocol stack. In some implementations, the CU 160 may host upper protocol layer (such as layer 3 (L3), layer 2 (L2)) functionality and signaling (such as Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (such as physical (PHY) layer) or L2 (such as radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (such as via one or more RUs 170). In some implementations, a functional split between a CU 160 and a DU 165, or between a DU 165 and an RU 170 may be within a protocol layer (such as some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (such as F1, F1-c, F1-u), and a DU 165 may be connected to one or more RUs 170 via a fronthaul communication link 168 (such as open fronthaul (FH) interface). In some implementations, a midhaul communication link 162 or a fronthaul communication link 168 may be implemented in accordance with an interface (such as a channel) between layers of a protocol stack supported by respective network entities 105 that are in communication over such communication links.

In wireless communications systems (such as wireless communications system 100), infrastructure and spectral resources for radio access may support wireless backhaul link capabilities to supplement wired backhaul connections, providing an integrated access backhaul (IAB) network architecture (such as to a core network 130). In some implementations, in an IAB network, one or more network entities 105 (such as IAB nodes 104) may be partially controlled by each other. One or more IAB nodes 104 may be referred to as a donor entity or an IAB donor. One or more DUs 165 (such as one or more RUs 170) may be partially controlled by CUs 160 associated with a donor network entity 105 (such as a donor BS 140). The one or more donor network entities 105 (such as IAB donors) may be in communication with one or more additional network entities 105 (such as IAB nodes 104) via supported access and backhaul links (such as backhaul communication links 120). IAB nodes 104 may include an IAB mobile termination (IAB-MT) controlled (such as scheduled) by DUs 165 of a coupled IAB donor. An IAB-MT may include an independent set of antennas for relay of communications with UEs 115, or may share the same antennas (such as of an RU 170) of an IAB node 104 used for access via the DU 165 of the IAB node 104 (such as referred to as virtual IAB-MT (vIAB-MT)). In some implementations, the IAB nodes 104 may include DUs 165 that support communication links with additional entities (such as IAB nodes 104, UEs 115) within the relay chain or configuration of the access network (such as downstream). In such implementations, one or more components of the disaggregated RAN architecture (such as one or more IAB nodes 104 or components of IAB nodes 104) may be configured to operate according to the techniques described herein.

For instance, an access network (AN) or RAN may include communications between access nodes (such as an IAB donor), IAB nodes 104, and one or more UEs 115. The IAB donor may facilitate connection between the core network 130 and the AN (such as via a wired or wireless connection to the core network 130). That is, an IAB donor may refer to a RAN node with a wired or wireless connection to core network 130. The IAB donor may include a CU 160 and at least one DU 165 (such as and RU 170), in which implementation the CU 160 may communicate with the core network 130 over an interface (such as a backhaul link). IAB donor and IAB nodes 104 may communicate over an F1 interface according to a protocol that defines signaling messages (such as an F1 AP protocol). Additionally, or alternatively, the CU 160 may communicate with the core network over an interface, which may be an example of a portion of backhaul link, and may communicate with other CUs 160 (such as a CU 160 associated with an alternative IAB donor) over an Xn-C interface, which may be an example of a portion of a backhaul link.

An IAB node 104 may refer to a RAN node that provides IAB functionality (such as access for UEs 115, wireless self-backhauling capabilities). A DU 165 may act as a distributed scheduling node towards child nodes associated with the IAB node 104, and the IAB-MT may act as a scheduled node towards parent nodes associated with the IAB node 104. That is, an IAB donor may be referred to as a parent node in communication with one or more child nodes (such as an IAB donor may relay transmissions for UEs through one or more other IAB nodes 104). Additionally, or alternatively, an IAB node 104 also may be referred to as a parent node or a child node to other IAB nodes 104, depending on the relay chain or configuration of the AN. Therefore, the IAB-MT entity of IAB nodes 104 may provide a Uu interface for a child IAB node 104 to receive signaling from a parent IAB node 104, and the DU interface (such as DUs 165) may provide a Uu interface for a parent IAB node 104 to signal to a child IAB node 104 or UE 115.

For example, IAB node 104 may be referred to as a parent node that supports communications for a child IAB node, and referred to as a child IAB node associated with an IAB donor. The IAB donor may include a CU 160 with a wired or wireless connection (such as a backhaul communication link 120) to the core network 130 and may act as parent node to IAB nodes 104. For example, the DU 165 of IAB donor may relay transmissions to UEs 115 through IAB nodes 104, and may directly signal transmissions to a UE 115. The CU 160 of IAB donor may signal communication link establishment via an F1 interface to IAB nodes 104, and the IAB nodes 104 may schedule transmissions (such as transmissions to the UEs 115 relayed from the IAB donor) through the DUs 165. That is, data may be relayed to and from IAB nodes 104 via signaling over an NR Uu interface to MT of the IAB node 104. Communications with IAB node 104 may be scheduled by a DU 165 of IAB donor and communications with IAB node 104 may be scheduled by DU 165 of IAB node 104.

In the implementation of the techniques described herein applied in the context of a disaggregated RAN architecture, one or more components of the disaggregated RAN architecture may be configured to support spatial domain precoders for serving cells as described herein. For example, some operations described as being performed by a UE 115 or a network entity 105 (such as a BS 140) may additionally, or alternatively, be performed by one or more components of the disaggregated RAN architecture (such as IAB nodes 104, DUs 165, CUs 160, RUs 170, RIC 170, SMO 180).

A UE 115 may include or may be referred to as a mobile device, a wireless device, a remote device, a handheld device, or a subscriber device, or some other suitable terminology, where the “device” also may be referred to as a unit, a station, a terminal, or a client, among other examples. A UE 115 also may include or may be referred to as a personal electronic device such as a cellular phone, a personal digital assistant (PDA), a tablet computer, a laptop computer, or a personal computer. In some implementations, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay BSs, among other examples, as shown in FIG. 1.

The UEs 115 and the network entities 105 may wirelessly communicate with one another via one or more communication links 125 (such as an access link) over one or more carriers. The term “carrier” may refer to a set of radio frequency spectrum resources having a defined physical layer structure for supporting the communication links 125. For example, a carrier used for a communication link 125 may include a portion of a radio frequency spectrum band (such as a bandwidth part (BWP)) that is operated according to one or more physical layer channels for a given radio access technology (such as LTE, LTE-A, LTE-A Pro, NR). Each physical layer channel may carry acquisition signaling (such as synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (such as entity, sub-entity) of a network entity 105. For example, the terms “transmitting,” “receiving,” or “communicating,” when referring to a network entity 105, may refer to any portion of a network entity 105 (such as a BS 140, a CU 160, a DU 165, a RU 170) of a RAN communicating with another device (such as directly or via one or more other network entities 105).

In some implementations, such as in a carrier aggregation configuration, a carrier also may have acquisition signaling or control signaling that coordinates operations for other carriers. A carrier may be associated with a frequency channel (such as an evolved universal mobile telecommunication system terrestrial radio access (E-UTRA) absolute RF channel number (EARFCN)) and may be positioned according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (such as of the same or a different radio access technology).

The communication links 125 shown in the wireless communications system 100 may include downlink transmissions (such as forward link transmissions) from a network entity 105 to a UE 115, uplink transmissions (such as return link transmissions) from a UE 115 to a network entity 105, or both, among other configurations of transmissions. Carriers may carry downlink or uplink communications (such as in an FDD mode) or may be configured to carry downlink and uplink communications (such as in a TDD mode).

A carrier may be associated with a particular bandwidth of the RF spectrum and, in some implementations, the carrier bandwidth may be referred to as a “system bandwidth” of the carrier or the wireless communications system 100. For example, the carrier bandwidth may be one of a set of bandwidths for carriers of a particular radio access technology (such as 1.4, 3, 5, 10, 15, 20, 40, or 80 megahertz (MHz)). Devices of the wireless communications system 100 (such as the network entities 105, the UEs 115, or both) may have hardware configurations that support communications over a particular carrier bandwidth or may be configurable to support communications over one of a set of carrier bandwidths. In some implementations, the wireless communications system 100 may include network entities 105 or UEs 115 that support concurrent communications via carriers associated with multiple carrier bandwidths. In some implementations, each served UE 115 may be configured for operating over portions (such as a sub-band, a BWP) or all of a carrier bandwidth.

Signal waveforms transmitted over a carrier may be made up of multiple subcarriers (such as using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (such as a duration of one modulation symbol) and one subcarrier, in which implementation the symbol period and subcarrier spacing may be inversely related. The quantity of bits carried by each resource element may depend on the modulation scheme (such as the order of the modulation scheme, the coding rate of the modulation scheme, or both) such that the more resource elements that a device receives and the higher the order of the modulation scheme, the higher the data rate may be for the device. A wireless communications resource may refer to a combination of a radio frequency spectrum resource, a time resource, and a spatial resource (such as a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (such as 10 milliseconds (ms)). Each radio frame may be identified by a system frame number (SFN) (such as ranging from 0 to 1023).

Each frame may include multiple consecutively numbered subframes or slots, and each subframe or slot may have the same duration. In some implementations, a frame may be divided (such as in the time domain) into subframes, and each subframe may be further divided into a quantity of slots. Alternatively, each frame may include a variable quantity of slots, and the quantity of slots may depend on subcarrier spacing. Each slot may include a quantity of symbol periods (such as depending on the length of the cyclic prefix prepended to each symbol period). In some wireless communications systems 100, a slot may further be divided into multiple mini-slots containing one or more symbols. Excluding the cyclic prefix, each symbol period may contain one or more (such as N_{f}) sampling periods. The duration of a symbol period may depend on the subcarrier spacing or frequency band of operation.

A subframe, a slot, a mini-slot, or a symbol may be the smallest scheduling unit (such as in the time domain) of the wireless communications system 100 and may be referred to as a transmission time interval (TTI). In some implementations, the TTI duration (such as a quantity of symbol periods in a TTI) may be variable. Additionally, or alternatively, the smallest scheduling unit of the wireless communications system 100 may be dynamically selected (such as in bursts of shortened TTIs (STTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (such as a control resource set (CORESET)) for a physical control channel may be defined by a set of symbol periods and may extend across the system bandwidth or a subset of the system bandwidth of the carrier. One or more control regions (such as CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (such as control channel elements (CCEs)) associated with encoded information for a control information format having a given payload size. Search space sets may include common search space sets configured for sending control information to multiple UEs 115 and UE-specific search space sets for sending control information to a specific UE 115.

A network entity 105 may provide communication coverage via one or more cells, for example a macro cell, a small cell, a hot spot, or other types of cells, or any combination thereof. The term “cell” may refer to a logical communication entity used for communication with a network entity 105 (such as over a carrier) and may be associated with an identifier for distinguishing neighboring cells (such as a physical cell identifier (PCID), a virtual cell identifier (VCID), or others). In some implementations, a cell also may refer to a coverage area 110 or a portion of a coverage area 110 (such as a sector) over which the logical communication entity operates. Such cells may range from smaller areas (such as a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (such as several kilometers in radius) and may allow unrestricted access by the UEs 115 with service subscriptions with the network provider supporting the macro cell. A small cell may be associated with a lower-powered network entity 105 (such as a lower-powered BS 140), as compared with a macro cell, and a small cell may operate in the same or different (such as licensed, unlicensed) frequency bands as macro cells. Small cells may provide unrestricted access to the UEs 115 with service subscriptions with the network provider or may provide restricted access to the UEs 115 having an association with the small cell (such as the UEs 115 in a closed subscriber group (CSG), the UEs 115 associated with users in a home or office). A network entity 105 may support one or multiple cells and also may support communications over the one or more cells using one or multiple component carriers.

In some implementations, a carrier may support multiple cells, and different cells may be configured according to different protocol types (such as MTC, narrowband IoT (NB-IoT), enhanced mobile broadband (eMBB)) that may provide access for different types of devices.

In some implementations, a network entity 105 (such as a BS 140, an RU 170) may be movable and therefore provide communication coverage for a moving coverage area 110. In some implementations, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some implementations, a UE 115 may be able to communicate directly with other UEs 115 over a device-to-device (D2D) communication link 135 (such as in accordance with a peer-to-peer (P2P), D2D, or sidelink protocol). In some implementations, one or more UEs 115 of a group that are performing D2D communications may be within the coverage area 110 of a network entity 105 (such as a BS 140, an RU 170), which may support aspects of such D2D communications being configured by or scheduled by the network entity 105. In some implementations, one or more UEs 115 in such a group may be outside the coverage area 110 of a network entity 105 or may be otherwise unable to or not configured to receive transmissions from a network entity 105. In some implementations, groups of the UEs 115 communicating via D2D communications may support a one-to-many (1:M) system in which each UE 115 transmits to each of the other UEs 115 in the group. In some implementations, a network entity 105 may facilitate the scheduling of resources for D2D communications. In some other examples, D2D communications may be carried out between the UEs 115 without the involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (such as a mobility management entity (MME), an access and mobility management function (AMF)) and at least one user plane entity that routes packets or interconnects to external networks (such as a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (such as BSs 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, which may be referred to as clusters, but the waves may penetrate structures sufficiently for a macro cell to provide service to the UEs 115 located indoors. The transmission of UHF waves may be associated with smaller antennas and shorter ranges (such as less than 100 kilometers) compared to transmission using the smaller frequencies and longer waves of the high frequency (HF) or very high frequency (VHF) portion of the spectrum below 300 MHz.

The wireless communications system 100 may utilize both licensed and unlicensed radio frequency spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. While operating in unlicensed radio frequency spectrum bands, devices such as the network entities 105 and the UEs 115 may employ carrier sensing for collision detection and avoidance. In some implementations, operations in unlicensed bands may be associated with a carrier aggregation configuration in conjunction with component carriers operating in a licensed band (such as LAA). Operations in unlicensed spectrum may include downlink transmissions, uplink transmissions, P2P transmissions, or D2D transmissions, among other examples.

A network entity 105 (such as a BS 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more BS antennas or antenna arrays may be co-located at an antenna assembly, such as an antenna tower. In some implementations, antennas or antenna arrays associated with a network entity 105 may be located in diverse geographic locations. A network entity 105 may have an antenna array with a set of rows and columns of antenna ports that the network entity 105 may use to support beamforming of communications with a UE 115. Likewise, a UE 115 may have one or more antenna arrays that may support various MIMO or beamforming operations. Additionally, or alternatively, an antenna panel may support radio frequency beamforming for a signal transmitted via an antenna port.

The network entities 105 or the UEs 115 may use MIMO communications to exploit multipath signal propagation and increase the spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (such as the same codeword) or different data streams (such as different codewords). Different spatial layers may be associated with different antenna ports used for channel measurement and reporting. MIMO techniques include single-user MIMO (SU-MIMO), where multiple spatial layers are transmitted to the same receiving device, and multiple-user MIMO (MU-MIMO), where multiple spatial layers are transmitted to multiple devices.

Beamforming, which also may be referred to as spatial filtering, directional transmission, or directional reception, is a signal processing technique that may be used at a transmitting device or a receiving device (such as a network entity 105, a UE 115) to shape or steer an antenna beam (such as a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (such as with respect to the antenna array of the transmitting device or receiving device, or with respect to some other orientation).

A network entity 105 or a UE 115 may use beam sweeping techniques as part of beamforming operations. For example, a network entity 105 (such as a BS 140, an RU 170) may use multiple antennas or antenna arrays (such as antenna panels) to conduct beamforming operations for directional communications with a UE 115. Some signals (such as synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (such as by a transmitting device, such as a network entity 105, or by a receiving device, such as a UE 115) a beam direction for later transmission or reception by the network entity 105.

Some signals, such as data signals associated with a particular receiving device, may be transmitted by transmitting device (such as a transmitting network entity 105, a transmitting UE 115) along a single beam direction (such as a direction associated with the receiving device, such as a receiving network entity 105 or a receiving UE 115). In some implementations, the beam direction associated with transmissions along a single beam direction may be determined according to a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some implementations, transmissions by a device (such as by a network entity 105 or a UE 115) may be performed using multiple beam directions, and the device may use a combination of digital precoding or beamforming to generate a combined beam for transmission (such as from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (such as a cell-specific reference signal (CRS), a CSI-RS), which may be precoded or unprecoded. The UE 115 may provide feedback for beam selection, which may be a precoding matrix indicator (PMI) or codebook-based feedback (such as a multi-panel type codebook, a linear combination type codebook, a port selection type codebook). Although these techniques are described with reference to signals transmitted along one or more directions by a network entity 105 (such as a BS 140, an RU 170), a UE 115 may employ similar techniques for transmitting signals multiple times along different directions (such as for identifying a beam direction for subsequent transmission or reception by the UE 115) or for transmitting a signal along a single direction (such as for transmitting data to a receiving device).

A receiving device (such as a UE 115) may perform reception operations in accordance with multiple receive configurations (such as directional listening) when receiving various signals from a receiving device (such as a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (such as different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some implementations, a receiving device may use a single receive configuration to receive along a single beam direction (such as when receiving a data signal). The single receive configuration may be aligned along a beam direction determined in response to listening according to different receive configuration directions (such as a beam direction determined to have a highest signal strength, highest signal-to-noise ratio (SNR), or otherwise acceptable signal quality in response to listening according to multiple beam directions).

In some implementations, the network entity 105 or the UE 115 may perform a beam sweeping operation (such as an SSB beam sweeping operation) as part of an initial access operation. Additionally, the network entity 105 or the UE 115 may perform SSB and random access channel (RACH) association as part of the initial access operation. In some implementations, the network entity 105 or the UE 115 may perform initial access operations including SSB beam sweeping, SSB and RACH association operations using wider beams (such as level 1 (L1) beams). In some implementations, the network entity 105 and the UE 115 may select a beam pair for communications between the network entity 105 and the UE 115 in response to performing the initial access operations (such as an SSB beam sweeping operation).

In some implementations, the network entity 105 or the UE 115 may perform one or more additional procedures in response to performing an initial access operation (such as in implementations where the network entity 105 or the UE 115 are in a connected mode). For example, the network entity 105 or the UE 115 may perform a procedure (such as phase 1 (P1) procedure) associated with an SSB beam sweeping operation or an initial transmission beam sweeping operation. Additionally, the network entity 105 or the UE 115 may perform a procedure (such as a phase 2 (P2) procedure) associated with a CSI-RS beam sweeping operation or a refinement sweeping operation. Additionally, the network entity 105 or the UE 115 may perform a procedure (such as a phase 3 (P3) procedure) associated with a CSI-RS beam sweeping operation or a reception beam refinement sweeping operation. In some instances of beam refinement, the network entity 105 or the UE 115 may rely on layer 1 reporting. In some implementations, the network entity 105 and the UE 115 may perform hierarchical beam refinement in response to performing the one or more additional procedures (such as P1, P2, and P3 procedures).

In implementations associated with a beam failure, a network entity 105 or a UE 115 may perform a beam failure recovery (BFR). For example, the network entity 105 may provide a set of resources for the BFR (such as via an RRC message prior to the beam failure) and the UE 115 may perform a RACH operation. Additionally, or alternatively, the network entity 105 or the UE 115 may detect a radio link failure (RLF).

In some implementations of the wireless communications system 100, a wireless device (such as the UE 115) may apply a spatial domain precoder for transmissions on a serving cell (such as beamformed transmissions). In some implementations, the wireless device may select the spatial domain precoder for the transmissions on the serving cell in accordance with spatial relation information that corresponds to one or more other transmissions transmitted or received by the wireless device on that serving cell. For example, the wireless device may apply a spatial domain precoder to an uplink transmission (such as an SRS transmission or an uplink data transmission) on a serving cell in accordance with spatial relation information associated with transmitting or receiving a reference signal on that serving cell. Additionally, or alternatively, a wireless device may communicate with a network entity 105 on more than one serving cell. Here, the wireless device may rely on spatial relation information associated with each of the serving cells to select corresponding spatial domain precoders to apply to uplink transmissions on the respective serving cells.

In some implementations of the wireless communications system 100 where a wireless device communicates with a network entity 105 via more than one serving cell, the wireless device may instead rely on spatial relation information associated with one serving cell to select a spatial domain precoder for uplink transmissions on another serving cell. For example, the wireless device may derive a spatial domain precoder for a transmission on a first serving cell using spatial relation information for transmitting or receiving reference signals on a second serving cell. Additionally, or alternatively, the wireless device may calculate the spatial domain precoder for a transmission on a first serving cell in response to monitoring a second serving cell for a downlink reference signal (such as an SSB transmission or a CSI-RS). Additionally, or alternatively, the wireless device may select a spatial domain precoder for a transmission on a first serving cell using uplink precoding information (such as TPMI) indicated for a second serving cell.

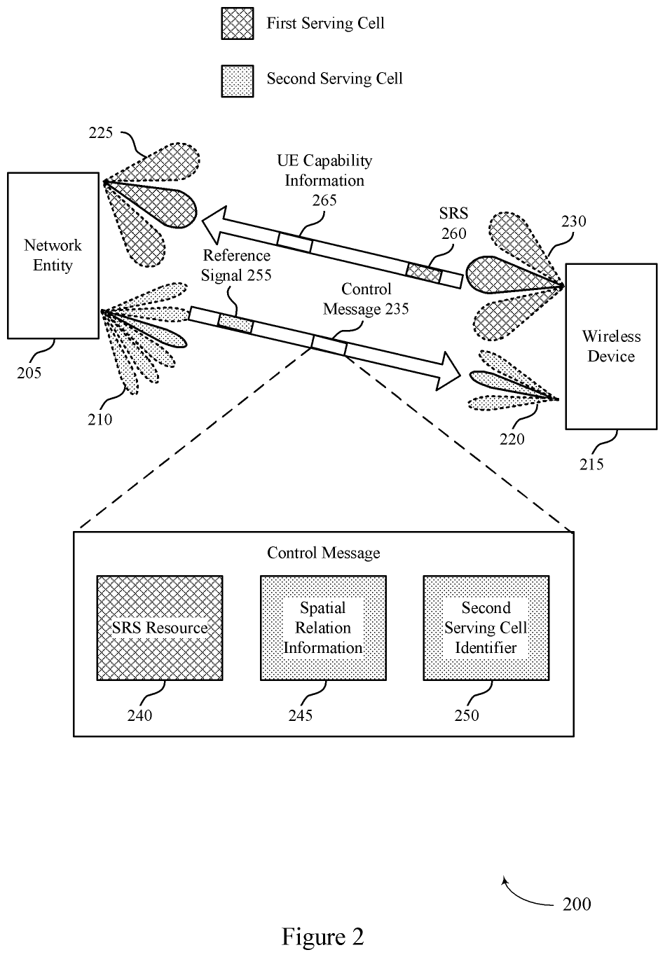

FIG. 2 shows an example signaling diagram 200 that supports spatial domain precoders for serving cells. The signaling diagram 200 may implement or be implemented to realize aspects of the wireless communications system 100. For example, the signaling diagram 200 may illustrate communication between a network entity 205 and a wireless device 215. The network entity 205 may be an example of a network entity 105 as illustrated by and described with reference to FIG. 1. Additionally, the wireless device 215 may be an example of a UE 115 as illustrated by and described with reference to FIG. 1.

The wireless device 215 may communicate with the network entity 205 via a first serving cell and a second serving cell. For example, the network entity 205 and the wireless device 215 may communicate on the first serving cell using the beams 225 and the beams 230, respectively. Additionally, the network entity 205 and the wireless device 215 may communicate on the second serving cell using the beams 210 and the beams 220, respectively. In some implementations, the first serving cell may be associated with a first range of frequencies and the second serving cell may be associated with a second range of frequencies different from the first range of frequencies. Additionally, or alternatively, the beams 225 and the beams 230 associated with communications on the first serving cell may be wider than the beams 210 and the beams 220 associated with communications on the second serving cell.

In some implementations, the wireless device 215 may apply a spatial domain precoder to transmissions to the network entity 205. For example, the wireless device 215 may apply a first spatial domain precoder to communications with the network entity 205 on the first serving cell (such as via beams 225 or beams 230). Additionally, the wireless device 215 may apply a second spatial domain precoder to communications with the network entity 205 on the second serving cell (such as via beams 210 or beams 220). In some implementations, the wireless device 215 may select a spatial domain precoder for transmissions to the network entity 205 on one serving cell in accordance with measured or indicated channel characteristics associated with that serving cell. For example, the wireless device 215 may monitor the second serving cell for the reference signal 255 and identify one or more channel metrics (such as in response to performing one or more channel measurements) corresponding to the second serving cell in response to monitoring the second serving cell for the reference signal 255. Additionally, the wireless device 215 may receive signaling indicating a configuration of the spatial relation information 245 associated with the second serving cell. In some implementations, the wireless device 215 may select a spatial domain precoder for communications on the second serving cell in accordance with identified channel metrics corresponding to the second serving cell, in accordance with the indicated spatial relation information 245 associated with the second serving cell, or both.

In the implementation of the signaling diagram 200, the wireless device 215 may instead select a spatial domain precoder for transmissions to the network entity 205 on one serving cell in accordance with spatial relation information associated with another serving cell. For example, the wireless device 215 select a spatial domain precoder for transmitting the SRS 260 on the first serving cell to the network entity 205 (such as via one or more of the beams 230) in accordance with the spatial relation information 245 associated with the second serving cell.

The network entity 205 may transmit a control message 235 to the wireless device 215 (such as on the first serving cell or on the second serving cell). The control message 235 may indicate an SRS resource 240. For example, the control message 235 may indicate the SRS resource 240 for the wireless device 215 to transmit the SRS 260 on the first serving cell. In some implementations, the network entity 205 may configure the SRS resource 240 to be associated with an SRS resource set that includes non-codebook SRS usage. For example, the network entity 205 may configure the SRS resource 240 to be associated with spatial domain precoders different from spatial domain precoders explicitly indicated by spatial relation information (such as spatial domain precoders that are selected in accordance with channel metrics or other parameters). In some implementations, the network entity 205 may transmit the control message 235 to the wireless device 215 via RRC signaling. Additionally, or alternatively, the control message 235 triggering the transmission of the SRS 260 via the SRS resource 240 on the first serving cell may include downlink control information (DCI), and the network entity 205 may transmit the control message 235 to the wireless device 215 via a control resource set including the downlink control information (DCI).

Additionally, the control message 235 may indicate spatial relation information 245 that is associated with the SRS resource 240. In the implementation of the signaling diagram 200, the spatial relation information 245 may be associated the second serving cell (such as in addition to being associated with the SRS resource 240 on the first serving cell). For example, the network entity 205 may transmit an indication of a configuration of the spatial relation information 245 to the wireless device 215 via RRC signaling. Additionally, the network entity 205 may transmit updates to the configuration of the spatial relation information 245 to the wireless device 215 via MAC-CE signaling.

In some implementations, the spatial domain precoder indicated by the spatial relation information 245 may be for transmitting or receiving signals on the second serving cell (such as the reference signal 255). For example, the wireless device 215 may apply a spatial domain precoder indicated by the spatial relation information 245 to receive the reference signal 255 (such as an SSB or a CSI-RS) on the second serving cell. In some implementations, the control message 235 including the SRS resource 240 and the indication of the spatial relation information 245 may associate the SRS resource 240 with the downlink reference signal 255 on the second serving cell. In some implementations, the control message 235 may indirectly indicate the second serving cell identifier 250 by indicating the spatial relation information 245, which is associated with the second serving cell. Additionally, or alternatively, the control message 235 may include the second serving cell identifier 250.

To transmit the SRS 260 on the first serving cell via the SRS resource 240 indicated in the control message 235, the wireless device 215 may select a spatial domain precoder. In some implementations, the spatial domain precoder indicated by the spatial relation information 245 may be for transmitting or receiving signals on the second serving cell (such as the reference signal 255). Thus, the wireless device 215 may derive a different spatial domain precoder (such as different from the spatial domain precoder indicated by the spatial relation information 245 for transmitting or receiving signals on the second serving cell) for transmitting the SRS 260 on the first serving cell. In some implementations, the wireless device 215 may select the spatial domain precoder different from the spatial domain precoder indicated by the spatial relation information 245 in response to the second serving cell identifier 250 indicated by the control message 235 being associated with a serving cell different from the serving cell associated with the SRS resource 240 (such as the first serving cell).

In some implementations, the wireless device 215 may select the spatial domain precoder for transmitting the SRS 260 in accordance with an ML function (such as corresponding to a DNN, a CNN, an RNN, or other examples of ML functions). For example, the wireless device 215 may apply the ML function to the spatial domain precoder indicated by the spatial relation information 245 (such as for receiving the reference signal 255 on the second serving cell) to obtain a spatial domain precoder for transmitting the SRS 260 on the first serving cell. In some implementations, the network entity 205 may indicate the ML function to the wireless device 215. Here, the wireless device 215 may select the spatial domain precoder for transmitting the SRS 260 in accordance with applying the ML function indicated by the network entity 205. Additionally, or alternatively, the wireless device 215 may transmit, to the network entity 205, an indication of the ML function applied to the spatial domain precoder for receiving the reference signal 255 on the second serving cell to obtain the spatial domain precoder for transmitting the SRS 260 on the first serving cell.

The wireless device 215 may transmit the SRS 260 to the network entity 205 on the first serving cell using the selected spatial domain precoder. In some implementations, the network entity 205 may determine (such as by performing corresponding channel measurements) one or more channel metrics corresponding to communications with the wireless device 215 on the second serving cell in response to receiving the SRS 260 on the first serving cell. For example, the network entity 205 may rely on the SRS 260 received on the first serving cell to schedule physical downlink shared channel (PDSCH) transmissions on the second serving cell to the wireless device 215, physical uplink shared channel (PUSCH) transmissions on the second serving cell from the wireless device 215, or both. In some implementations, the wireless device 215 may transmit, to the network entity 205, UE capability information 265 indicating a time interval between receiving the control message 235 and transmitting the SRS 260. For example, the wireless device 215 may indicate a time interval between a last symbol for receiving the control message 235 and a first symbol for transmitting the SRS 260. In some instances, a time interval between the wireless device 215 receiving the control message 235 and the wireless device 215 transmitting the SRS 260 may be greater than or equal to the time interval indicated by the UE capability information 265.

In some implementations, relying on an SRS 260 received on the first serving cell to determine, ascertain, calculate, or otherwise detect channel metrics associated with the second serving cell may decrease latency associated with communications between the network entity 205 and the wireless device 215 (such as compared with the network entity 205 relying on an SRS received on the second serving cell to determine channel metrics associated with second serving cell). For example, implementing digital beamforming at the network entity 205 and the wireless device 215 may enable different beams (such as beams associated with different serving cells) to be transmitted and received simultaneously. Additionally, relying on an SRS 260 received on the first serving cell to determine, ascertain, calculate, or otherwise detect channel metrics associated with the second serving cell may be associated with less scheduling restrictions as compared to relying on an SRS received on the second serving cell to determine channel metrics associated with the second serving cell. For example, the network entity 205 performing time domain beam sweeping operations with the beams 210 on the second serving cell may increase scheduling restrictions as compared to performing time domain beam sweeping operations with beams 225 on the first serving cell.

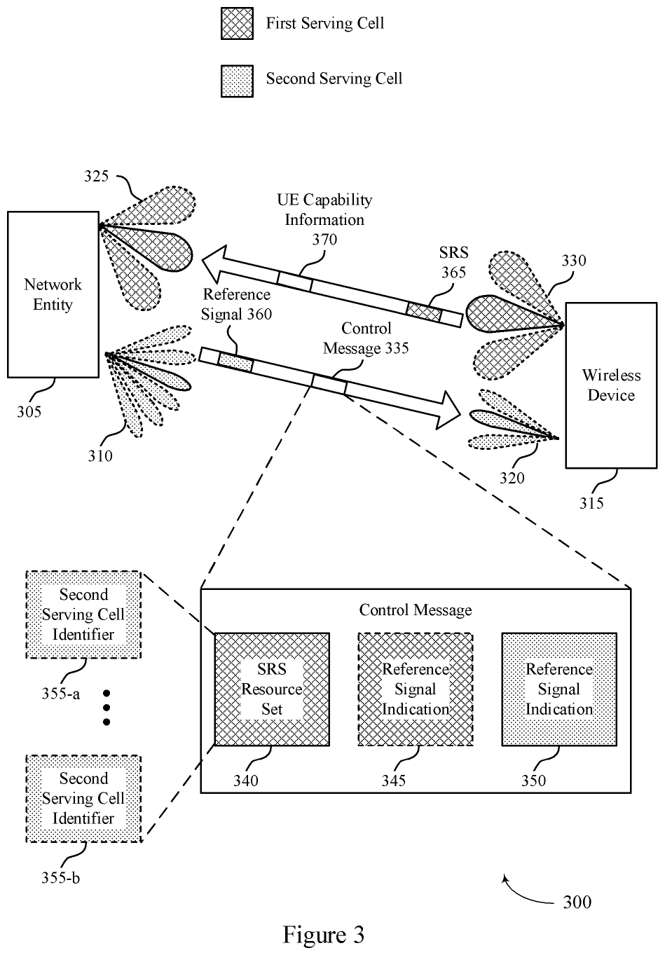

FIG. 3 shows an example signaling diagram 300 that supports spatial domain precoders for serving cells. The signaling diagram 300 may implement or be implemented to realize aspects of the wireless communications system 100 or the signaling diagram 200. For example, the signaling diagram 300 may illustrate communication between a network entity 305 and a wireless device 315. The network entity 305 may be an example of a network entity 105 as illustrated by and described with reference to FIG. 1 or a network entity 205 as illustrated by and described with reference to FIG. 2. Additionally, the wireless device 315 may be an example of a UE 115 as illustrated by and described with reference to FIG. 1 or a wireless device 215 as illustrated by and described with reference to FIG. 2.

The wireless device 315 may communicate with the network entity 305 via a first serving cell and a second serving cell. For example, the network entity 305 and the wireless device 315 may communicate on the first serving cell using the beams 325 and the beams 330, respectively. Additionally, the network entity 305 and the wireless device 315 may communicate on the second serving cell using the beams 310 and the beams 320, respectively. In some implementations, the first serving cell may be associated with a first range of frequencies and the second serving cell may be associated with a second range of frequencies different from the first range of frequencies. Additionally, or alternatively, the beams 325 and the beams 330 associated with communications on the first serving cell may be wider than the beams 310 and the beams 320 associated with communications on the second serving cell.

In some implementations, the wireless device 315 may apply a spatial domain precoder to transmissions to the network entity 305. For example, the wireless device 315 may apply a first spatial domain precoder to communications with the network entity 305 on the first serving cell (such as via beams 325 or beams 330). Additionally, the wireless device 315 may apply a second spatial domain precoder to communications with the network entity 305 on the second serving cell (such as via beams 310 or beams 320). In some implementations, the wireless device 315 may select a spatial domain precoder for transmissions to the network entity 305 on one serving cell in accordance with measured or indicated channel characteristics associated with that serving cell. For example, the wireless device 315 may monitor the second serving cell for the reference signal 360 and identify, ascertain, determine, or otherwise calculate one or more channel metrics corresponding to the second serving cell in response to monitoring the second serving cell for the reference signal 360. Additionally, the wireless device 315 may receive signaling indicating a configuration of the spatial relation information associated with the second serving cell. In some implementations, the wireless device 315 may select a spatial domain precoder for communications on the second serving cell in accordance with identified channel metrics corresponding to the second serving cell, in accordance with the indicated spatial relation information associated with the second serving cell, or both.

In the implementation of the signaling diagram 300, the wireless device 315 may instead select a spatial domain precoder for transmissions to the network entity 305 on one serving cell in response to monitoring another serving cell for a reference signal 360 (such as an SSB or a CSI-RS). For example, the wireless device 315 select a spatial domain precoder for transmitting the SRS 365 on the first serving cell to the network entity 305 (such as via one or more of the beams 330) in accordance with performing channel measurements on the second serving cell.

The network entity 305 may transmit a control message 335 to the wireless device 315 (such as on the first serving cell or on the second serving cell). The control message 335 may indicate an SRS resource set 340. For example, the control message 335 may indicate the SRS resource set 340 for the wireless device 315 indicating a set of resources for transmitting the SRS 365 on the first serving cell. In some implementations, the network entity 305 may configure the SRS resource set 340 to include non-codebook SRS usage. For example, the network entity 305 may configure the SRS resource set 340 to be associated with spatial domain precoders different from spatial domain precoders explicitly indicated by spatial relation information (such as spatial domain precoders that are selected in accordance with channel metrics or other parameters). In some implementations, the network entity 305 may transmit the control message 335 to the wireless device 315 via RRC signaling. Additionally, or alternatively, the control message 335 may be a DCI message associated with a control resource set, such that the DCI triggers the SRS resource set 340 on the first serving cell.

Additionally, or alternatively, the control message 335 may include a reference signal indication 350 associated with a reference signal 360 on the second serving cell. For example, the network entity 305 may transmit, to the wireless device 315, control signaling (such as RRC signaling) configuring the reference signal 360 on the second serving cell. Additionally, the control message 335 may include reference signal indication 350, which may indicate spatial relation information associating the SRS resource set 340 with the reference signal 360. For example, the network entity 305 may transmit signaling (such as via a MAC-CE or via DCI) indicating the reference signal 360 for the SRS resource set 340 (such as via the reference signal indication 350 in the control message 335).

In some implementations (such as implementations where the SRS resource set 340 is aperiodic or semi-persistent), the control message 335 may additionally include a reference signal indication 345 associated with a reference signal on the first serving cell (such as a CSI-RS or an SSB transmitted by the network entity 305 on the second serving cell). The reference signal indication 345 may indicate spatial relation information associating the SRS resource set 340 with a reference signal on the first serving cell. In implementations where the control message 335 includes both the reference signal indication 345 associated with a reference signal on the first serving cell and the reference signal indication 350 associated with the reference signal 360 on the second serving cell, the network entity 305 may transmit additional signaling. For example, the network entity 305 may transmit signaling indicating whether the wireless device 315 is to select a spatial domain precoder for the SRS resource set 340 in accordance with spatial relation information associating the SRS resource set 340 with the reference signal 360 (such as spatial relation information indicated by the reference signal indication 350) or in accordance with spatial relation information associating the SRS resource set 340 with a reference signal on the first serving cell (such as spatial relation information indicated by the reference signal indication 345).

In implementations where the SRS resource set 340 is aperiodic, the network entity 305 may transmit signaling via DCI (such as via an enhanced SRS request field in DCI) to the wireless device 315 indicating whether determining, obtaining, or otherwise selecting the spatial domain precoder for the SRS resource set 340 is in accordance with spatial relation information indicated by the reference signal indication 350 or in accordance with spatial relation information indicated by the reference signal indication 345. Additionally, or alternatively, in implementations where the SRS resource set 340 is semipersistent, the network entity 305 may transmit signaling via a MAC-CE (such as via an enhanced SRS request field in the MAC-CE) to the wireless device 315 indicating whether determining, obtaining or otherwise selecting the spatial domain precoder for the SRS resource set 340 is in accordance with spatial relation information indicated by the reference signal indication 350 or in accordance with spatial relation information indicated by the reference signal indication 345.

In some implementations, the SRS resource set 340 configured on the first serving cell may include one or more second serving cell identifiers 355. For example, the SRS resource set 340 may include a set of second serving cell identifiers 355 (such as first second serving cell identifier 355-a and another second serving cell identifier 355-b). In some implementations, each of the second serving cell identifiers 355 may correspond to a reference signal identifier indicating a reference signal 360 on the second serving cell. For example, the second serving cell identifier 355-a may correspond to one or more identifiers each indicating a reference signal on the second serving cell (such as the reference signal 360). Additionally, or alternatively, the second serving cell identifier 355-b also may correspond to one or more identifiers each indicating a reference signals on the second serving cell. In an implementation where the SRS resource set 340 is periodic, the SRS resource set 340 may include a single serving cell identifier 355. Here, the serving cell identifier may in turn include the reference signal indication 350 of the reference signal 360 on the second serving cell.

In some other implementations where the SRS resource set 340 is semipersistent, the SRS resource set 340 may include one or more second serving cell identifiers 355. In cases that the SRS resource set 340 includes (such as is configured with) more than one second serving cell identifier 355, the network entity 305 may transmit signaling indicating one of the second serving cell identifiers 355. For example, the network entity 305 may transmit signaling (such as via a MAC-CE) activating the SRS resource set 340 and activating a second serving cell corresponding to one of the second serving cell identifiers 355. Here, the wireless device 315 may determine that or otherwise rely on the spatial domain precoder for the SRS resource set 340 is in accordance with spatial relation information indicated by a reference signal corresponding to the indicated second serving cell identifier 355.

To transmit the SRS 365 on the first serving cell over the SRS resource set 340 indicated in the control message 335, the wireless device 315 may select a spatial domain precoder. In some implementations, the spatial domain precoder associated with the spatial relation information (such as the spatial relation information associating the SRS resource set 340 with the reference signal 360) may be for receiving the reference signal 360 on the second serving cell. For example, the wireless device 315 may apply a spatial domain precoder indicated by the spatial relation information associating the SRS resource set 340 with the reference signal 360 to receive the reference signal 360 on the second serving cell. Thus, the wireless device 315 may calculate a different spatial domain precoder (such as different from the spatial domain precoder associating the SRS resource set 340 with the reference signal 360) for transmitting the SRS 365 on the first serving cell.

In some implementations, the wireless device 315 may select the spatial domain precoder for transmitting the SRS 365 in response to performing one or more channel measurements on the second serving cell. For example, the wireless device 315 may monitor the second serving for the reference signal 360 and may identify, ascertain, determine, or otherwise calculate one or more channel metrics associated with the first serving cell in response to the monitoring. In some implementations, the wireless device 315 may calculate a spatial domain precoder to use for transmitting the SRS 365 on the first serving cell using the identified channel metrics associated with the first serving cell.

Additionally, or alternatively, the wireless device 315 may select the spatial domain precoder for transmitting the SRS 365 according to an ML function (such as corresponding to a DNN, a CNN, an RNN, or other examples of ML functions). For example, the wireless device 315 may apply the ML function to the spatial relation information associating the SRS resource set 340 with the reference signal 360 to obtain a spatial domain precoder for transmitting the SRS 365 on the first serving cell. In some implementations, the network entity 305 may indicate the ML function to the wireless device 315. Here, the wireless device 315 may select the spatial domain precoder for transmitting the SRS 365 in accordance with applying the ML function indicated by the network entity 305. Additionally, or alternatively, the wireless device 315 may transmit, to the network entity 305, an indication of the ML function applied to the spatial relation information associating the SRS resource set 340 with the reference signal 360 to obtain the spatial domain precoder for transmitting the SRS 365 on the first serving cell.

The wireless device 315 may transmit the SRS 365 to the network entity 305 on the first serving cell using the selected spatial domain precoder. In some implementations, the network entity 305 may determine, ascertain, obtain, or otherwise detect one or more channel metrics corresponding to communications with the wireless device 315 on the second serving cell in response to receiving the SRS 365 on the first serving cell. For example, the network entity 305 may rely on the SRS 365 received on the first serving cell to schedule PDSCH transmissions on the second serving cell to the wireless device 315, PUSCH transmissions on the second serving cell from the wireless device 315, or both. In some implementations, the wireless device 315 may transmit, to the network entity 305, UE capability information 370 indicating a time interval between receiving the control message 335 and transmitting the SRS 365. For example, the wireless device 315 may indicate a time interval between a last symbol for receiving the control message 335 and a first symbol for transmitting the SRS 365. In some instances, a time interval between the wireless device 315 receiving the control message 335 and the wireless device 315 transmitting the SRS 365 may be greater than or equal to the time interval indicated by the UE capability information 370.

In some implementations, relying on an SRS 365 received on the first serving cell to determine, ascertain, obtain, or otherwise detect channel metrics associated with the second serving cell may decrease latency associated with communications between the network entity 305 and the wireless device 315 (such as compared with the network entity 305 relying on an SRS received on the second serving cell to determine channel metrics associated with second serving cell). For example, implementing digital beamforming at the network entity 305 and the wireless device 315 may enable different beams (such as beams associated with different serving cells) to be transmitted and received simultaneously. Additionally, relying on an SRS 365 received on the first serving cell to determine, ascertain, obtain, or otherwise detect channel metrics associated with the second serving cell may be associated with less scheduling restrictions as compared to relying on an SRS received on the second serving cell to determine channel metrics associated with the second serving cell. For example, the network entity 305 performing time domain beam sweeping operations with the beams 310 on the second serving cell may increase scheduling restrictions as compared to performing time domain beam sweeping operations with beams 325 on the first serving cell.

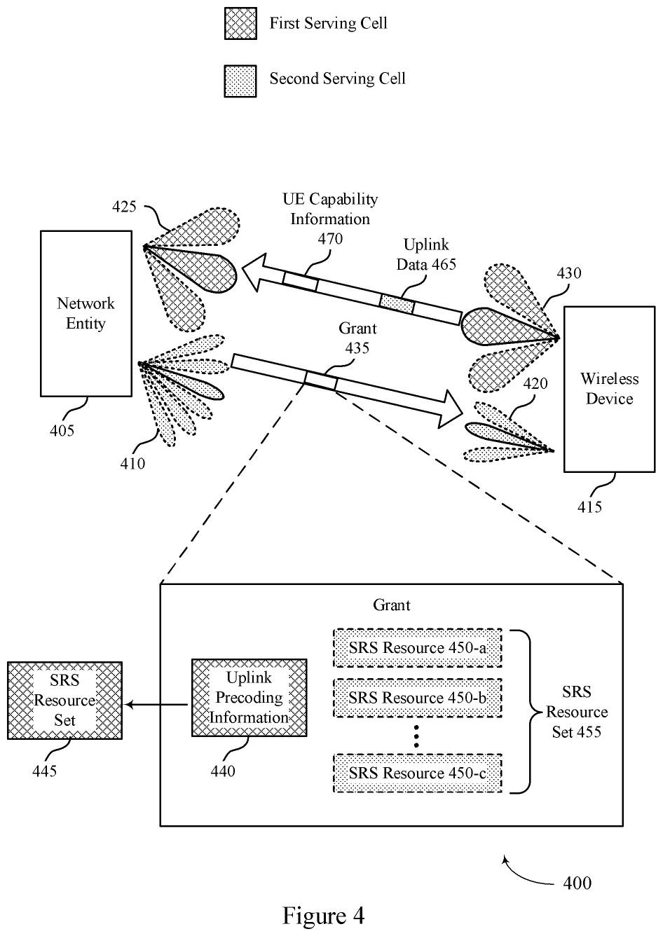

FIG. 4 shows an example signaling diagram 400 that supports spatial domain precoders for serving cells. The signaling diagram 400 may implement or be implemented to realize aspects of the wireless communications system 100, signaling diagram 200, or the signaling diagram 300. For example, the signaling diagram 400 may illustrate communication between a network entity 405 and a wireless device 415. The network entity 405 may be an example of a network entity 105, a network entity 205, or a network entity 305 as illustrated by and described with reference to FIG. 1, FIG. 2, and FIG. 3, respectively. Additionally, the wireless device 415 may be an example of a UE 115, a wireless device 215, or a wireless device 315 as illustrated by and described with reference to FIG. 1, FIG. 2, and FIG. 3, respectively.

The wireless device 415 may communicate with the network entity 405 via a first serving cell and a second serving cell. For example, the network entity 405 and the wireless device 415 may communicate on the first serving cell using the beams 425 and the beams 430, respectively. Additionally, the network entity 405 and the wireless device 415 may communicate on the second serving cell using the beams 410 and the beams 420, respectively. In some implementations, the first serving cell may be associated with a first range of frequencies and the second serving cell may be associated with a second range of frequencies different from the first range of frequencies. Additionally, or alternatively, the beams 425 and the beams 430 associated with communications on the first serving cell may be wider than the beams 410 and the beams 420 associated with communications on the second serving cell.

In some implementations, the wireless device 415 may apply a spatial domain precoder to transmissions to the network entity 405. For example, the wireless device 415 may apply a first spatial domain precoder to communications with the network entity 405 on the first serving cell (such as via beams 425 or beams 430). Additionally, the wireless device 415 may apply a second spatial domain precoder to communications with the network entity 405 on the second serving cell (such as via beams 410 or beams 420).

In the implementation of the signaling diagram 400, the wireless device 415 may select a spatial domain precoder for transmissions to the network entity 405 on one serving cell using uplink precoding information associated with another serving cell. For example, the wireless device 415 may receive in indication of uplink precoding information 440 associated with an SRS resource set 445 on the first serving cell and may rely on that uplink precoding information to select a spatial domain precoder for transmitting uplink data 465 on the second serving cell.

The network entity 405 may transmit, to the wireless device 415, an indication of a grant 435 (such as an uplink grant) on the first serving cell or the second serving cell. The grant 435 may indicate resources for the wireless device 415 to transmit the uplink data 465 (such as via a PUSCH) to the network entity 405 on the second serving cell. In some implementations, the network entity 405 may additionally indicate uplink precoding information 440 associated with an SRS resource set 445 that is defined in the first serving cell. For example, the network entity 405 may transmit signaling (such as associated with the grant 435) to the wireless device 415 indicating an SRI corresponding to the SRS resource set 445 (defined in the first serving cell), uplink precoding information 440 (such as a TPMI) associated with the SRS resource set 445, or both. In some implementations, the grant 435 may include the uplink precoding information 440, which may in turn indicate the SRS resource set 445. Additionally, or alternatively, the network entity 405 may transmit signaling (such as associated with the grant 435) to the wireless device 415 indicating multiple SRS resources 450 associated with an SRS resource set 455 defined in the second serving cell. In some implementations, a periodicity of the SRS resources 450 within the SRS resource set 455 may be longer than a periodicity of the SRS resources within the SRS resource set 445.

In some implementations, the wireless device 415 may be configured with an SRS usage for the SRS resource set 445. For example, the network entity 405 may indicate that the SRS resource set is associated with cross frequency range precoding (such as a CrossFRnonCodebook usage or a CrossFRCodebook usage). In some instances, the usage associated with the SRS resource set 445 may be different from other usages associated with SRS resource sets 445 (such as a usage different from beamManagement, codebook, nonCodebook, antennaSwitching).

In some implementations, the network entity 405 may transmit additional information to the wireless device 415 (such as in addition to the grant 435). For example, the network entity 405 may transmit information associated with the first serving cell in accordance with the SRS resource set 445 being defined in the first serving cell. Here, the network entity 405 may transmit, to the wireless device 415, signaling indicating or configuring one or more of a channel on the second serving cell corresponding to the SRS resource set 445, an angle of arrival associated with the channel on the second serving cell corresponding to the SRS resource set 445 (such as at the wireless device 415), and an angle of departure associated with the channel on the second serving cell corresponding to the SRS resource set 445 (such as from the wireless device 415). Additionally, or alternatively, the network entity 405 may transmit information associated with the second serving cell in accordance with the SRS resource set 445 being defined in the second serving cell. For example, the network entity 405 may transmit, to the wireless device 415, signaling indicating or configuring one or more of a channel on the first serving cell corresponding to the SRS resource set 445, an angle of arrival associated with the channel on the first serving cell corresponding to the SRS resource set 445 (such as at the wireless device 415), and an angle of departure associated with the channel on the first serving cell corresponding to the SRS resource set 445 (such as from the wireless device 415).

To transmit the uplink data 465 on the second serving cell over the resources indicated by the grant 435, the wireless device 415 may select a spatial domain precoder. In some implementations, the uplink precoding information 440 included in the grant may be for transmitting an SRS on the first serving cell. For example, the wireless device 415 may use the uplink precoding information 440 to transmit an SRS to the network entity 405 on the first serving cell (such as via the SRS resource set 445). Thus, the wireless device 415 may calculate a different spatial domain precoder (such as different from the uplink precoding information 440) for transmitting the uplink data 465 on the second serving cell.

In some implementations, the wireless device 415 may select a spatial domain precoder for transmitting the uplink data 465 in accordance with the uplink precoding information 440 in response to a serving cell identifier associated with the SRS resource set 445 being different from a serving cell identifier corresponding to the serving cell associated with transmitting the uplink data 465. For example, the grant 435 may include the serving cell identifier for the first serving cell in response to the SRS resource set 445 being associated with the first serving cell that is different from a serving cell identifier of the second serving cell. Additionally, or alternatively, the wireless device 415 may select a spatial domain precoder for transmitting the uplink data 465 in accordance with the uplink precoding information 440 in response to receiving the grant 435 on the first serving cell scheduling the transmission of the uplink data 465 on the second serving cell. That is, the wireless device 415 may select a spatial domain precoder for transmitting the uplink data 465 in accordance with the uplink precoding information 440 in response to the grant being scheduled according to cross-carrier scheduling. Additionally, or alternatively, the wireless device 415 may select a spatial domain precoder for transmitting the uplink data 465 in accordance with the uplink precoding information 440 in response to a difference in frequency resources between the first serving cell and the second serving cell (such as the first serving cell corresponding to different frequency bands than the second serving cell).

In some implementations, the wireless device 415 may select the spatial domain precoder for transmitting the uplink data 465 on the second serving cell according to the uplink precoding information 440 associated with the SRS resource set on the first serving cell. Additionally, or alternatively, the wireless device 415 may select the spatial domain precoder for transmitting the uplink data 465 according to a rank of the PUSCH on the second serving cell (such as the PUSCH associated with transmitting the uplink data 465). In some implementations, the wireless device 415 may identify, ascertain, determine, or otherwise select the rank of the PUSCH on the second serving cell in response to receiving the indication of the uplink precoding information 440 associated with the first serving cell, the SRS resource set 445 defined on the first serving cell, or both (such as in the grant 435).

Additionally, or alternatively, the wireless device 415 may select the spatial domain precoder for transmitting the uplink data 465 according to an ML function (such as corresponding to a DNN, a CNN, an RNN, or other examples of ML functions). For example, the wireless device 415 may apply the ML function to the uplink precoding information 440 to obtain the spatial domain precoder for transmitting the uplink data 465 on the second serving cell. In some implementations, the ML function may be associated with one or more additional inputs (such as in addition to the uplink precoding information 440). For example, the wireless device 415 also may input one or more of the SRS resource set 445 defined on the first serving cell, the one or more SRS resources 450 on the second serving cell, and one or more channel metrics of the first or second serving cells estimated by the wireless device 415 (such as in response to monitoring the first or second serving cells for a reference signal transmission from the network entity 405) to the ML function.

Additionally, or alternatively, the wireless device 415 may input the additional information associated with the first serving cell and the second serving cell (such as the additional information indicated to the wireless device 415 by the network entity 405) to the ML function to obtain the spatial domain precoder for transmitting the uplink data 465. For example, the wireless device 415 may input one or more of the angles of arrival and departure associated with a channel on the first serving cell or the second serving cell corresponding with the SRS resource set 445 or the SRS resource set 455 and the channel associated with the SRS resource set 445 or the channel associated with the SRS resource set 455 (such as the channels indicated to the wireless device 415 by the network entity 405). In some implementations, the network entity 405 may indicate the ML function to the wireless device 415. Here, the wireless device 415 may select the spatial domain precoder for transmitting the uplink data 465 in accordance with applying the ML function indicated by the network entity 405.

In some implementations, the wireless device 415 may determine, ascertain, obtain, or otherwise select a coherence type, a rank, or both for transmitting the uplink data 465 on the second serving cell using the uplink precoding information 440 and the SRS resource set 445 associated with the first serving cell. For example, the wireless device 415 may transmit, to the network entity 405, an indication of a maximum rank corresponding to the uplink precoding information 440 (such as in accordance with the SRS resource set 445 defined on the first serving cell). Additionally, or alternatively, the wireless device 415 may transmit, to the network entity 405, an indication of one or more coherence types associated with the uplink precoding information 440. For example, the wireless device 415 may indicate a capability to support uplink precoding information (such as TPMI) associated with a codebook (such as a codebookSubset=partialAndNonCoherent) in response to receiving the indication of the uplink precoding information 440 within the grant 435. In some implementations, the uplink precoding information 440 may indicate a first rank in accordance with a coherence type (such as a codebookSubset coherence type including partialAndNonCoherent, NonCoherent, or fullAndPartialAndNonCoherent).

In some implementations, the wireless device 415 may determine, ascertain, determine, or otherwise select the coherence type and the rank of the uplink data 465 transmission (such as via a PUSCH on the second serving cell) in response to identifying or otherwise calculating the rank and coherence type associated with the uplink precoding information 440 and the SRS resource set 445. For example, the wireless device 415 may apply an ML function to the rank and coherence type associated with the uplink precoding information 440 and the SRS resource set 445 to obtain the rank and coherence type for transmitting the uplink data 465. For example, in an implementation where the uplink precoding information 440 indicates a rank2 and rank2 partial-coherence precoding (such as associated with the SRS resource set 445), the wireless device 415 may transmit the uplink data 465 using a rank2 spatial domain precoder. In another example, in an implementation where the grant 435 indicates an SRI associated with a non-codebook and fully-coherent rank4 precoding, the wireless device 415 may transmit the uplink data 465 using a fully coherent-rank4 spatial domain precoder.

In some implementations, the wireless device 415 may transmit, to the network entity 405, UE capability information 470 indicating a time interval between receiving the grant 435 and transmitting the uplink data 465. For example, the wireless device 415 may indicate a time interval between a last symbol for receiving the grant 435 (such as via a control resource set including DCI communicating the grant 435) and a first symbol for transmitting the uplink data 465. In some instances, a time interval between the wireless device 415 receiving the grant 435 and the wireless device 415 transmitting the uplink data 465 may be greater than or equal to the time interval indicated by the UE capability information 470.

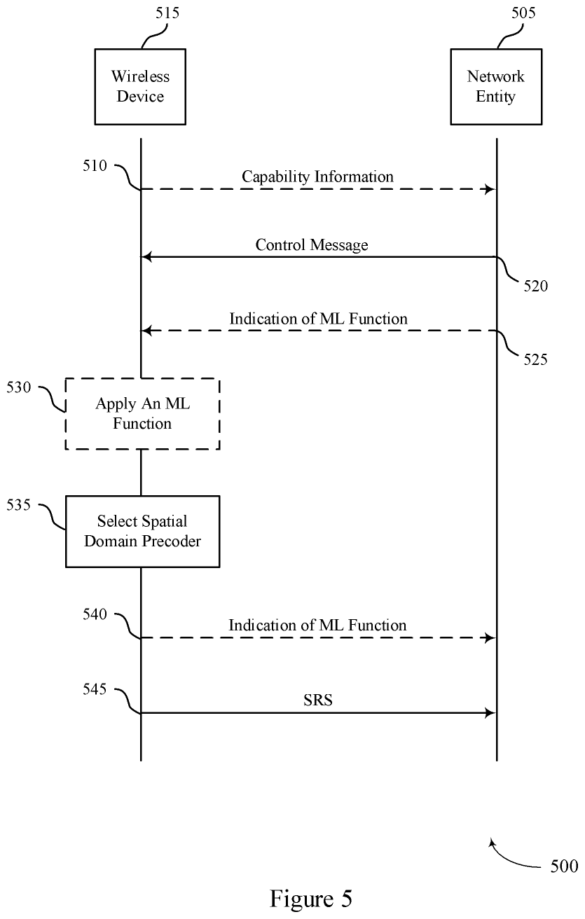

FIG. 5 shows an example process flow 500 that supports spatial domain precoders for serving cells. The process flow 500 may implement or be implemented to realize aspects of the wireless communications system 100, the signaling diagram 200, the signaling diagram 300, and the signaling diagram 400. For example, the process flow 500 may illustrate communication between a network entity 505 and a wireless device 515. The network entity 505 may be an example of a network entity 105, a network entity 205, a network entity 305, or a network entity 405 as illustrated by and described with reference to FIG. 1, FIG. 2, FIG. 3, and FIG. 4, respectively. Additionally, the wireless device 515 may be an example of a UE 115, a wireless device 215, a wireless device 315, or a wireless device 415 as illustrated by and described with reference to FIG. 1, FIG. 2, FIG. 3, and FIG. 4, respectively.

At 510, the wireless device 515 may optionally transmit capability information (such as UE capability information) to the network entity 505. That is, the wireless device 515 may transmit capability information indicating a time interval between receiving a control message indicating an SRS resource and transmitting the SRS.

At 520, the network entity 505 may transmit the control message to the wireless device 515. The control message may indicate an SRS resource on a first serving cell and spatial relation information for the SRS resource, where the spatial relation information associated with SRS resource with a downlink reference signal on a second serving cell. In some implementations, the SRS resource may be associated with an SRS resource set including a non-codebook SRS usage. Additionally, or alternatively, the network entity 505 may transmit the control message to the wireless device 515 via RRC signaling.

At 525, the network entity 505 may optionally transmit an indication of an ML function to the wireless device 515.

At 530, the wireless device 515 may optionally apply an ML function to the second spatial domain precoder to obtain the first spatial domain precoder. For example, the wireless device 515 may apply the ML function to a second spatial domain precoder that is associated with the downlink reference signal on the second serving cell to obtain a first spatial domain precoder for transmitting the SRS on the first serving cell. In some implementations where the network entity 505 transmits the indication of the ML function to the wireless device 515 at 525, the wireless device 515 may apply the indicated ML function to the second spatial domain precoder to obtain the first spatial domain precoder.

At 535, the wireless device 515 may select the first spatial domain precoder for transmitting the SRS according to the second spatial domain precoder (such as the spatial domain precoder that is associated with the downlink reference signal on the second serving cell). In some implementations (such as implementations where the wireless device 515 applied the ML function to the second spatial domain precoder), the wireless device 515 may select the first spatial domain precoder in response to applying the ML function. Additionally, or alternatively, the wireless device 515 may select the first spatial domain precoder according to the second spatial domain precoder according to a difference between a first frequency range associated with the first serving cell and a second frequency range associated with the second serving cell.

At 540, the wireless device 515 may optionally transmit an indication of the ML function to the network entity 505.

At 545, the wireless device 515 may transmit the SRS via the SRS resource on the first serving cell using the first spatial domain precoder to the network entity 505. In some implementations, the wireless device 515 may transmit the SRS after a period of time from receiving the control message at 520 that is equal to or greater than the time interval indicated in the UE capability information (such as at 510).

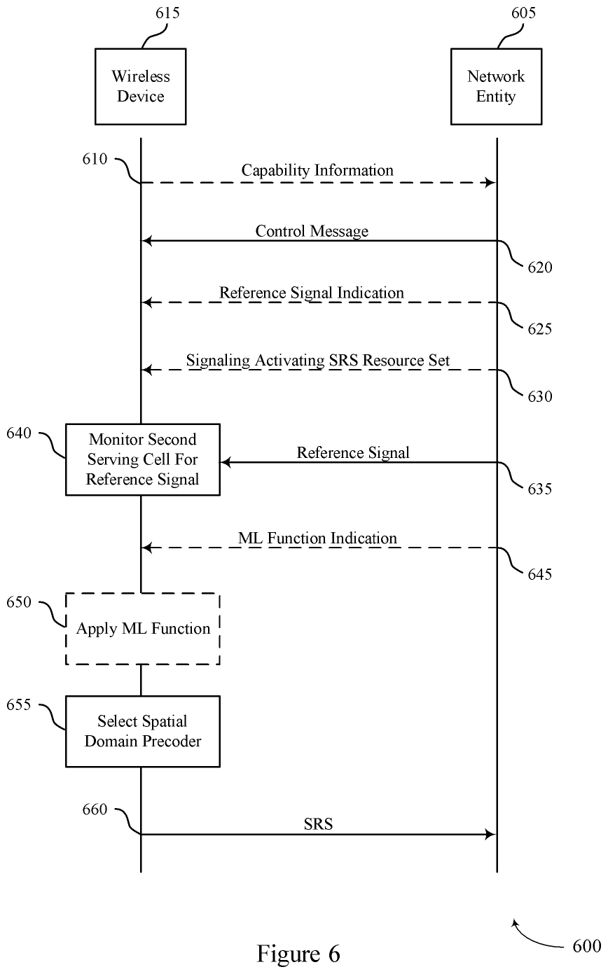

FIG. 6 shows an example process flow 600 that supports spatial domain precoders for serving cells. The process flow 600 may implement or be implemented to realize aspects of the wireless communications system 100, the signaling diagram 200, the signaling diagram 300, the signaling diagram 400, or the process flow 500. For example, the process flow 600 may illustrate communication between a network entity 605 and a wireless device 615. The network entity 605 may be an example of a network entity 105, a network entity 205, a network entity 305, a network entity 405, or a network entity 505 as illustrated by and described with reference to FIG. 1, FIG. 2, FIG. 3, FIG. 4, and FIG. 5, respectively. Additionally, the wireless device 615 may be an example of a UE 115, a wireless device 215, a wireless device 315, a wireless device 415, or a wireless device 515 as illustrated by and described with reference to FIG. 1, FIG. 2, FIG. 3, FIG. 4, and FIG. 5, respectively.

At 610, the wireless device 615 may optionally transmit capability information (such as UE capability information) to the network entity 605. That is, the wireless device 615 may transmit capability information indicating a time interval between receiving a control message indicating an SRS resource and transmitting the SRS.

At 620, the network entity 605 may transmit a control message to the wireless device 615. The control message may indicate a configuration of an SRS resource set for transmitting the SRS on a first serving cell. In some implementations, the SRS resource set may be associated with a non-codebook SRS usage. Additionally, or alternatively, the control message may indicate spatial relation information associating the SRS resource set with a downlink reference signal on a second serving cell (such as an SSB or a CSI-RS). In an implementation where the SRS is periodic, the control message may include an identifier of the second serving cell. Additionally, or alternatively, in an implementation where the SRS is semipersistent, the control message may include a set of identifiers corresponding to a set of serving cells (that includes the second serving cell).

At 625, the network entity 605 may optionally transmit a reference signal indication to the wireless device 615. For example, in some implementations the spatial relation information may associate the SRS resource set with a set of downlink reference signals on one or more serving cells. Here, the network entity 605 may transmit the reference signal indication at 625 indicating one reference signal from the set of downlink reference signals, where the indicated reference signal is on the second serving cell. In some implementations where the SRS is aperiodic, the network entity 605 may transmit an SRS request field of a DCI indicating the reference signal on the second serving cell for the SRS resource set at 625. Additionally, or alternatively, in some implementations where the SRS is semipersistent, the network entity 605 may transmit a MAC-CE activating the SRS resource set for transmitting the SRS and indicating the downlink reference signal on the second serving cell.

At 630, the network entity 605 may optionally transmit signaling activating the SRS resource set to the wireless device 615. That is, in implementations where the SRS is semipersistent, the network entity 605 may transmit a MAC-CE activating the SRS resource set and activating the second serving cell (such as from the set of serving cells defined by the network entity 605 in the control message at 620).

At 635, the network entity 605 may transmit, on the second serving cell, the reference signal to the wireless device 615 (such as the downlink reference signal associated with the SRS resource set by the spatial relation information indicated in the control message).

At 640, the wireless device 615 may monitor the second serving cell for the downlink reference signal according to the spatial relation information. In some implementations, the wireless device 615 may perform channel measurements on the second serving cell in response to monitoring for the downlink reference signal.

At 645, the network entity 605 may optionally transmit an indication of an ML function to the wireless device 615. At 650, the wireless device 615 may optionally apply an ML function to the spatial relation information associated with the downlink reference signal on the second serving cell to obtain a spatial domain precoder for transmitting the SRS over the SRS resource set on the first serving cell. In some implementations where the network entity 605 transmits an indication of the ML function at 645, the wireless device 615 may apply the ML function indicated by the network entity 605 to obtain the spatial domain precoder.

At 655, the wireless device 615 may select a spatial domain precoder for transmitting the SRS over the SRS resource set on the first serving cell. In an implementation where the wireless device 615 applies the ML function at 650, the wireless device 615 may select the spatial domain precoder in response to obtaining the spatial domain precoder from the ML function. Additionally, or alternatively, the wireless device 615 may select the spatial domain precoder for transmitting the SRS over the SRS resource set in response to performing channel measurements on the second serving cell.

At 660, the wireless device 615 may transmit the SRS over the SRS resource set on the first serving cell using the selected spatial domain precoder. In some implementations, the wireless device 615 may transmit the SRS after a period of time from receiving the control message at 620 that is equal to or greater than the time interval indicated in the UE capability information (such as at 610).

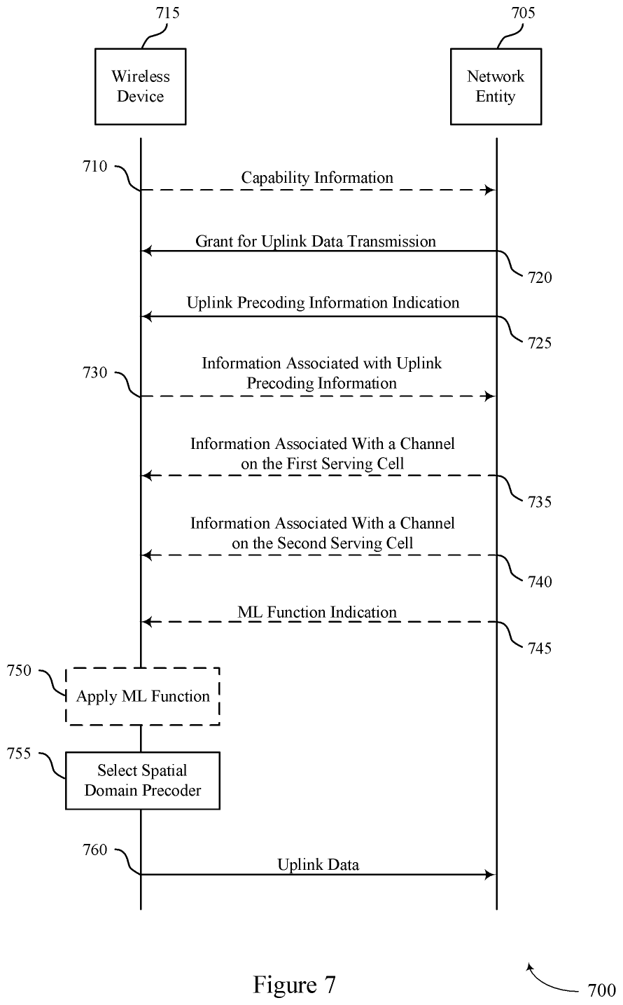

FIG. 7 shows an example process flow 700 that supports spatial domain precoders for serving cells. The process flow 700 may implement or be implemented to realize aspects of the wireless communications system 100, the signaling diagram 200, the signaling diagram 300, the signaling diagram 400, the process flow 500, or the process flow 600. For example, the process flow 700 may illustrate communication between a network entity 705 and a wireless device 715. The network entity 705 may be an example of a network entity 105, a network entity 205, a network entity 305, a network entity 405, a network entity 505, or a network entity 605 as illustrated by and described with reference to FIG. 1, FIG. 2, FIG. 3, FIG. 4, FIG. 5, and FIG. 6, respectively. Additionally, the wireless device 715 may be an example of a UE 115, a wireless device 215, a wireless device 315, a wireless device 415, a wireless device 515, or a wireless device 615 as illustrated by and described with reference to FIG. 1, FIG. 2, FIG. 3, FIG. 4, FIG. 5, and FIG. 6, respectively.

At 710, the wireless device 715 may optionally transmit capability information (such as UE capability information) to the network entity 705. That is, the wireless device 715 may transmit capability information indicating a time interval between receiving signaling indicating a grant (such as an uplink grant for a PUSCH transmission) and transmitting uplink data according to the grant.

At 720, the network entity 705 may transmit, to the wireless device 715, a grant for transmitting uplink data on a first serving cell.

At 725, the network entity 705 may transmit, to the wireless device 715, an indication of uplink precoding information (such as TPMI) associated with an SRS resource set of a second serving cell. In some implementations, the network entity 705 may transmit the indication of the uplink precoding information associated with the SRS resource set of the second serving cell in the grant (such as at 720). In some implementations, the uplink precoding information may indicate one or more SRS resource sets associated with the first serving cell. For example, the uplink precoding information may indicate one or more SRS resource sets associated with the first serving cell and corresponding to a longer periodicity as compared to the SRS resource set on the second serving cell. In some implementations, the wireless device 715 may additionally receive signaling indicating that the SRS resource set of the second serving cell is associated with cross frequency range precoding.

At 730, the wireless device 715 may optionally indicate information associated with the uplink precoding information associated with the SRS resource set of the second serving cell. For example, the wireless device 715 may transmit, to the network entity 705, an indication of a maximum rank corresponding to the uplink precoding information, one or more coherence types associated with the uplink precoding information, or both.

At 735, the wireless device 715 may optionally receive, from the network entity 705, information associated with a channel on the first serving cell. For example, the wireless device 715 may receive, from the network entity 705, an indication of one or more of the channel on the first serving cell (such as an explicit indication of the channel), an angle of arrival associated with the channel on the first serving cell corresponding to the one or more SRS resource sets of the first serving cell, and an angle of departure associated with the channel on the first serving cell corresponding to the one or more SRS resource sets of the first serving cell.

At 740, the wireless device 715 may optionally receive, from the network entity 705, information associated with a channel on the second serving cell. For example, the wireless device 715 may receive, from the network entity 705, an indication of one or more of a channel on the second serving cell (such as an explicit indication of the channel), an angle of arrival associated with the channel on the second serving cell corresponding to the SRS resource set of the first serving cell, and an angle of departure associated with the channel on the second serving cell corresponding to the SRS resource set of the first serving cell.

At 745, the network entity 705 may optionally transmit an indication of an ML function to the wireless device 715. At 750, the wireless device 715 may optionally apply the ML function to the uplink precoding information to obtain a spatial domain precoder associated with the second serving cell and for transmitting the uplink data on the first serving cell. In some implementations, the wireless device 715 may additionally apply the ML function to one or more of the information associated with the one or more SRS resource sets of the first serving cell received at 735, the information associated with the SRS resource set of the second serving cell received at 740, one or more channel estimations performed by the wireless device 715 on the first serving cell or the second serving cell, the one or more SRS resource sets on the first serving cell, and the SRS resource set on the second serving cell.

At 755, the wireless device 715 may select the spatial domain precoder associated with the second serving cell using the uplink precoding information (such as based on the uplink precoding information) received in the indication of the grant and associated with the SRS resource set of the second serving cell. In some implementations, the wireless device 715 may select the spatial domain precoder in response to applying the ML function to the uplink precoding information.

At 760, the wireless device 715 may transmit uplink data on the first serving cell according to the grant and using the spatial domain precoder selected at 755. In some implementations, the wireless device 715 may transmit the uplink data in accordance with the indication of the maximum rank transmitted by the wireless device 715 at 730.

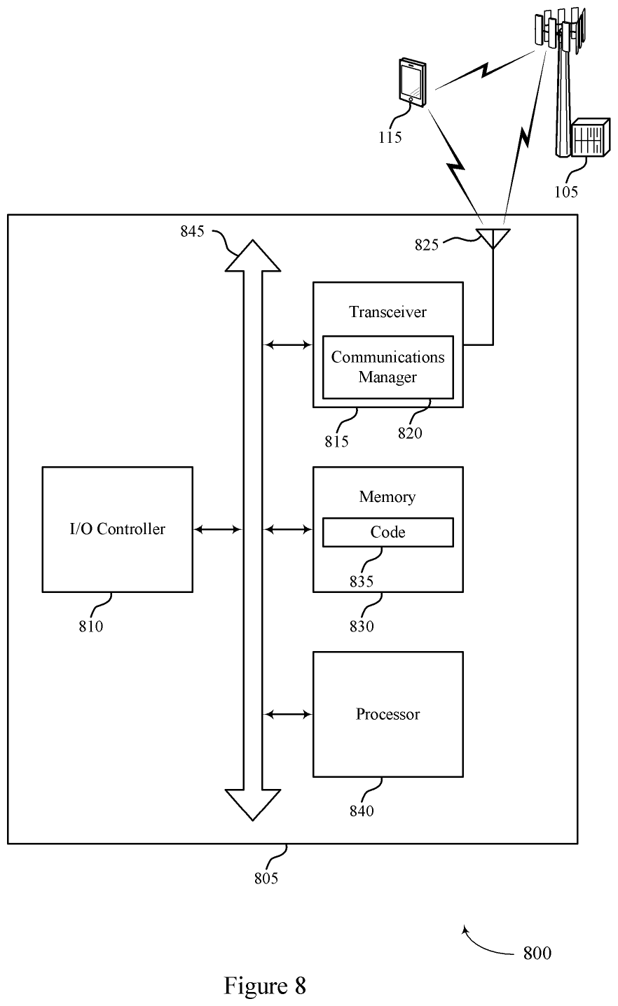

FIG. 8 shows a block diagram 800 of an example device 805 that supports spatial domain precoders for serving cells in accordance with one or more aspects of the present disclosure. The device 805 may communicate (such as wirelessly) with one or more network entities 105, one or more UEs 115, or any combination thereof. The device 805 may include components for bi-directional voice and data communications including components for transmitting and receiving communications, such as a communications manager 820, an I/O controller 810, a transceiver 815, an antenna 825, a memory 830, code 835, and a processor 840. These components may be in electronic communication or otherwise coupled (such as operatively, communicatively, functionally, electronically, electrically) via one or more buses (such as a bus 845).

The I/O controller 810 may manage input and output signals for the device 805. The I/O controller 810 also may manage peripherals not integrated into the device 805. In some implementations, the I/O controller 810 may represent a physical connection or port to an external peripheral. In some implementations, the I/O controller 810 may utilize an operating system such as iOS®, ANDROID®, MS-DOS®, MS-WINDOWS®, OS/2®, UNIX®, LINUX®, or another known operating system. Additionally, or alternatively, the I/O controller 810 may represent or interact with a modem, a keyboard, a mouse, a touchscreen, or a similar device. In some implementations, the I/O controller 810 may be implemented as part of a processor or processing system, such as the processor 840. In some implementations, a user may interact with the device 805 via the I/O controller 810 or via hardware components controlled by the I/O controller 810.

In some implementations, the device 805 may include a single antenna 825. However, in some other implementations, the device 805 may have more than one antenna 825, which may be capable of concurrently transmitting or receiving multiple wireless transmissions. The transceiver 815 may communicate bi-directionally, via the one or more antennas 825, wired, or wireless links as described herein. For example, the transceiver 815 may represent a wireless transceiver and may communicate bi-directionally with another wireless transceiver. The transceiver 815 also may include a modem to modulate the packets, to provide the modulated packets to one or more antennas 825 for transmission, and to demodulate packets received from the one or more antennas 825. In some implementations, the transceiver 815 may include one or more interfaces, such as one or more interfaces coupled with the one or more antennas 825 that are configured to support various receiving or obtaining operations, or one or more interfaces coupled with the one or more antennas 825 that are configured to support various transmitting or outputting operations, or a combination thereof. In some implementations, the transceiver 815 may include or be configured for coupling with one or more processors or memory components that are operable to perform or support operations based on received or obtained information or signals, or to generate information or other signals for transmission or other outputting, or any combination thereof. In some implementations, the transceiver 815, or the transceiver 815 and the one or more antennas 825, or the transceiver 815 and the one or more antennas 825 and one or more processors or memory components (for example, the processor 840, or the memory 830, or both), may be included in a chip or chip assembly that is installed in the device 805.

The memory 830 may include random access memory (RAM) and read-only memory (ROM). The memory 830 may store computer-readable, computer-executable code 835 including instructions that, when executed by the processor 840, cause the device 805 to perform various functions described herein. The code 835 may be stored in a non-transitory computer-readable medium such as system memory or another type of memory. In some implementations, the code 835 may not be directly executable by the processor 840 but may cause a computer (for example, when compiled and executed) to perform functions described herein. In some implementations, the memory 830 may contain, among other things, a basic I/O system (BIOS) which may control basic hardware or software operation such as the interaction with peripheral components or devices.

The processor 840 may be any one or more suitable processors capable of executing scripts or instructions of one or more software programs stored in the device 805 (such as within the memory 830). In some implementations, the processor 840 may be a component of a processing system. A processing system may generally refer to a system or series of machines or components that receives inputs and processes the inputs to produce a set of outputs (which may be passed to other systems or components of, for example, the device 805). For example, a processing system of the device 805 may refer to a system including the various other components or subcomponents of the device 805, such as the processor 840, or the transceiver 815, or the communications manager 820, or other components or combinations of components of the device 805.

The processing system of the device 805 may interface with other components of the device 805, and may process information received from other components (such as inputs or signals) or output information to other components. For example, a chip or modem of the device 805 may include a processing system and an interface to output information, or to obtain information, or both. The interface may be implemented as or otherwise include a first interface configured to output information and a second interface configured to obtain information. In some implementations, the first interface may refer to an interface between the processing system of the chip or modem and a transmitter, such that the device 805 may transmit information output from the chip or modem. In some implementations, the second interface may refer to an interface between the processing system of the chip or modem and a receiver, such that the device 805 may obtain information or signal inputs, and the information may be passed to the processing system. A person having ordinary skill in the art will readily recognize that the first interface also may obtain information or signal inputs, and the second interface also may output information or signal outputs.

The communications manager 820 may support wireless communication at a device in accordance with examples as disclosed herein. For example, the communications manager 820 may be configured as or otherwise support a means for receiving a control message indicating an SRS resource on a first serving cell and spatial relation information for the SRS resource, where the spatial relation information associates the SRS resource with a downlink reference signal on a second serving cell. The communications manager 820 may be configured as or otherwise support a means for selecting a first spatial domain precoder for transmitting an SRS according to a second spatial domain precoder associated with the downlink reference signal on the second serving cell. The communications manager 820 may be configured as or otherwise support a means for transmitting the SRS via the SRS resource on the first serving cell using the first spatial domain precoder.

In some implementations, the communications manager 820 may be configured as or otherwise support a means for transmitting UE capability information indicating a time interval between receiving the control message indicating the SRS resource and transmitting the SRS.

In some implementations, to select the first spatial domain precoder, the communications manager 820 may be configured as or otherwise support a means for applying an ML function to the second spatial domain precoder to obtain the first spatial domain precoder.

In some implementations, the communications manager 820 may be configured as or otherwise support a means for receiving an indication of the ML function, where applying the ML function to the second spatial domain precoder may be in accordance with receiving the indication of the ML function.

In some implementations, the communications manager 820 may be configured as or otherwise support a means for transmitting an indication of the ML function applied to the second spatial domain precoder to obtain the first spatial domain precoder.

In some implementations, the SRS resource may be associated with an SRS resource set including a non-codebook SRS usage.

In some implementations, the communications manager 820 may be configured as or otherwise support a means for selecting the first spatial domain precoder may be further according to a difference between a first range of frequencies associated with the first serving cell and a second range of frequencies associated with the second serving cell.

In some implementations, the communications manager 820 may be configured as or otherwise support a means for selecting the first spatial domain precoder may be in response to receiving the control message indicating the SRS resource on the first serving cell when the reference signal may be associated with the second serving cell.

In some implementations, the control message includes an RRC message.

Additionally, or alternatively, the communications manager 820 may support wireless communication at a device in accordance with examples as disclosed herein. For example, the communications manager 820 may be configured as or otherwise support a means for receiving a control message indicating a configuration of an SRS resource set for transmitting an SRS on a first serving cell and indicating spatial relation information associating the SRS resource set with a downlink reference signal on a second serving cell. The communications manager 820 may be configured as or otherwise support a means for monitoring the second serving cell for the downlink reference signal according to the spatial relation information. The communications manager 820 may be configured as or otherwise support a means for selecting a spatial domain precoder for transmitting the SRS over the SRS resource set on the first serving cell according to the control message and the monitoring. The communications manager 820 may be configured as or otherwise support a means for transmitting the SRS over the SRS resource set on the first serving cell using the selected spatial domain precoder.

In some implementations, the spatial relation information associates the SRS resource set with a set of multiple downlink reference signals on a set of one or more serving cells including the second serving cell. Here, the communications manager 820 may be configured as or otherwise support a means for receiving an indication that the downlink reference signal on the second serving cell may be selected from the set of multiple downlink reference signals for the SRS resource set.

In some implementations, the communications manager 820 may be configured as or otherwise support a means for receiving an SRS request field of a DCI indicating the downlink reference signal on the second serving cell for SRS resource set, where the SRS may be aperiodic and receiving a MAC-CE activating the SRS resource set for transmitting the SRS and indicating the downlink reference signal on the second serving cell, where the SRS may be semipersistent.

In some implementations, the SRS may be periodic and the control message includes an identifier of the second serving cell.

In some implementations, the SRS may be semipersistent and the control message includes a set of multiple identifiers corresponding to a set of multiple serving cells. Here, the communications manager 820 may be configured as or otherwise support a means for receiving a MAC-CE activating the SRS resource set and activating the second serving cell, where monitoring the second serving cell for the downlink reference signal may be based on receiving the MAC-CE.

In some implementations, to select the spatial domain precoder, the communications manager 820 may be configured as or otherwise support a means for applying an ML function to the spatial relation information to obtain the spatial domain precoder.

In some implementations, the communications manager 820 may be configured as or otherwise support a means for receiving an indication of the ML function, where applying the ML function to the spatial relation information may be in accordance with receiving the indication of the ML function.

In some implementations, the communications manager 820 may be configured as or otherwise support a means for transmitting UE capability information indicating a time interval between receiving the control message indicating the SRS resource set and transmitting the SRS.

In some implementations, the SRS resource set may be associated with a non-codebook SRS usage.

In some implementations, the first serving cell may be associated with a first range of frequencies and the second serving cell may be associated with a second range of frequencies different from the first range of frequencies.

Additionally, or alternatively, the communications manager 820 may support wireless communication at a device in accordance with examples as disclosed herein. For example, the communications manager 820 may be configured as or otherwise support a means for receiving an indication of a grant for transmitting uplink data on a first serving cell and uplink precoding information associated with an SRS resource set of a second serving cell. The communications manager 820 may be configured as or otherwise support a means for selecting a spatial domain precoder associated with the second serving cell based on the uplink precoding information received in the indication of the grant and associated with the SRS resource set of the second serving cell. The communications manager 820 may be configured as or otherwise support a means for transmitting the uplink data on the first serving cell according to the grant and using the selected spatial domain precoder.

In some implementations, the communications manager 820 may be configured as or otherwise support a means for receiving an indication of a channel on the second serving cell corresponding to the SRS resource set of the second serving cell, an angle of arrival associated with the channel on the second serving cell corresponding to the SRS resource set of the second serving cell, an angle of departure associated with the channel on the second serving cell corresponding to the SRS resource set of the second serving cell, or a combination thereof, where selecting the spatial domain precoder is in accordance with the channel on the second serving cell corresponding to the SRS resource set of the second serving cell, the angle of arrival associated with the channel on the second serving cell corresponding to the SRS resource set of the second serving cell, the angle of departure associated with the channel on the second serving cell corresponding to the SRS resource set of the second serving cell, or the combination thereof.

In some implementations, the uplink precoding information further indicates one or more SRS resource sets associated with the first serving cell.

In some implementations, the communications manager 820 may be configured as or otherwise support a means for receiving an indication of a channel on the first serving cell corresponding to the SRS resource set of the second serving cell, an angle of arrival associated with the channel on the first serving cell corresponding to the SRS resource set of the second serving cell, an angle of departure associated with the channel on the first serving cell corresponding to the SRS resource set of the second serving cell, or a combination thereof, where selecting the spatial domain precoder is in accordance with the channel on the first serving cell corresponding to the SRS resource set of the second serving cell, the angle of arrival associated with channel on the first serving cell corresponding to the SRS resource set of the second serving cell, the angle of departure associated with the channel on the first serving cell corresponding to the SRS resource set of the second serving cell, or the combination thereof.

In some implementations, to select the spatial precoder, the communications manager 820 may be configured as or otherwise support a means for applying an ML function to the uplink precoding information to obtain the spatial domain precoder.

In some implementations, the communications manager 820 may be configured as or otherwise support a means for receiving an indication of the ML function, where applying the ML function to the uplink precoding information may be in accordance with receiving the indication of the ML function.

In some implementations, the communications manager 820 may be configured as or otherwise support a means for transmitting an indication of a maximum rank corresponding to the uplink precoding information, one or more coherence types associated with the uplink precoding information, or both, where the spatial domain precoder may be selected in accordance with the maximum rank corresponding to the uplink precoding information, the one or more coherence types associated with the uplink precoding information, or both; where transmitting the uplink data may be in accordance with the indication of the maximum rank.

In some implementations, the communications manager 820 may be configured as or otherwise support a means for transmitting the uplink data on the first serving cell using the spatial domain precoder in response to one or more of: the indication of the grant including an identifier associated with the second serving cell, the indication of the grant being received via the second serving cell, a difference in frequency resources between the first serving cell and the second serving cell, or a combination thereof.

In some implementations, the communications manager 820 may be configured as or otherwise support a means for transmitting a UE capability message indicating a time interval between receiving signaling indicating the grant and transmitting the uplink data using the selected spatial domain precoder.

In some implementations, the communications manager 820 may be configured as or otherwise support a means for receiving signaling indicating that the SRS resource set of the second serving cell may be associated with cross frequency range precoding.

In some implementations, the communications manager 820 may be configured to perform various operations (for example, receiving, monitoring, transmitting) using or otherwise in cooperation with the transceiver 815, the one or more antennas 825, or any combination thereof. Although the communications manager 820 is illustrated as a separate component, in some implementations, one or more functions described with reference to the communications manager 820 may be supported by or performed by the processor 840, the memory 830, the code 835, or any combination thereof. For example, the code 835 may include instructions executable by the processor 840 to cause the device 805 to perform various aspects of spatial domain precoders for serving cells as described herein, or the processor 840 and the memory 830 may be otherwise configured to perform or support such operations.

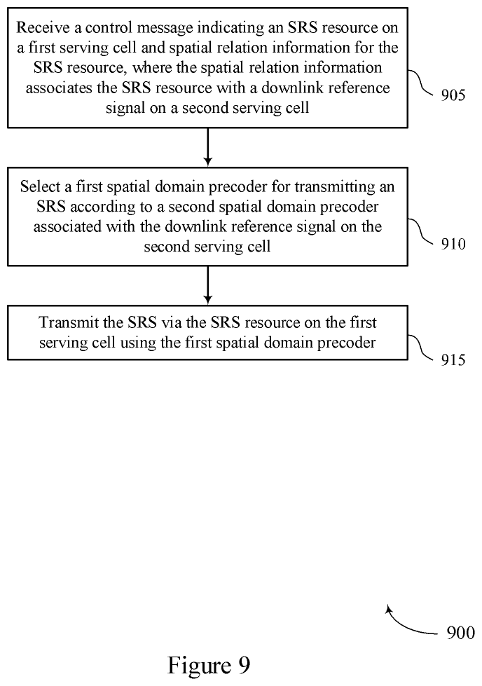

FIG. 9 shows a flowchart illustrating an example method 900 that supports spatial domain precoders for serving cells in accordance with one or more aspects of the present disclosure. The operations of the method 900 may be implemented by a device or its components as described herein. For example, the operations of the method 900 may be performed by a device as described with reference to FIGS. 1-8. In some implementations, a device may execute a set of instructions to control the functional elements of the device to perform the described functions. Additionally, or alternatively, the device may perform aspects of the described functions using special-purpose hardware.

At 905, the method may include receiving a control message indicating an SRS resource on a first serving cell and spatial relation information for the SRS resource, where the spatial relation information associates the SRS resource with a downlink reference signal on a second serving cell. The operations of 905 may be performed in accordance with examples as disclosed herein.

At 910, the method may include selecting a first spatial domain precoder for transmitting an SRS according to a second spatial domain precoder associated with the downlink reference signal on the second serving cell. The operations of 910 may be performed in accordance with examples as disclosed herein.

At 915, the method may include transmitting the SRS via the SRS resource on the first serving cell using the first spatial domain precoder. The operations of 915 may be performed in accordance with examples as disclosed herein.

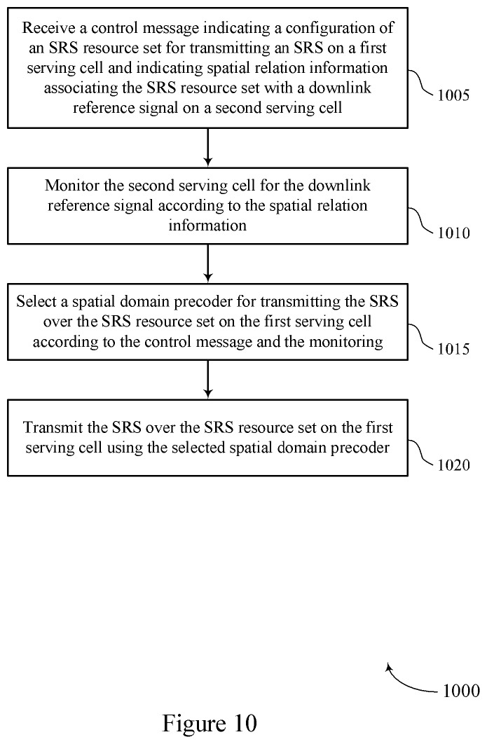

FIG. 10 shows a flowchart illustrating an example method 1000 that supports spatial domain precoders for serving cells in accordance with one or more aspects of the present disclosure. The operations of the method 1000 may be implemented by a device or its components as described herein. For example, the operations of the method 1000 may be performed by a device as described with reference to FIGS. 1-8. In some implementations, a device may execute a set of instructions to control the functional elements of the device to perform the described functions. Additionally, or alternatively, the device may perform aspects of the described functions using special-purpose hardware.

At 1005, the method may include receiving a control message indicating a configuration of an SRS resource set for transmitting an SRS on a first serving cell and indicating spatial relation information associating the SRS resource set with a downlink reference signal on a second serving cell. The operations of 1005 may be performed in accordance with examples as disclosed herein.

At 1010, the method may include monitoring the second serving cell for the downlink reference signal according to the spatial relation information. The operations of 1010 may be performed in accordance with examples as disclosed herein.

At 1015, the method may include selecting a spatial domain precoder for transmitting the SRS over the SRS resource set on the first serving cell according to the control message and the monitoring. The operations of 1015 may be performed in accordance with examples as disclosed herein.

At 1020, the method may include transmitting the SRS over the SRS resource set on the first serving cell using the selected spatial domain precoder. The operations of 1020 may be performed in accordance with examples as disclosed herein.

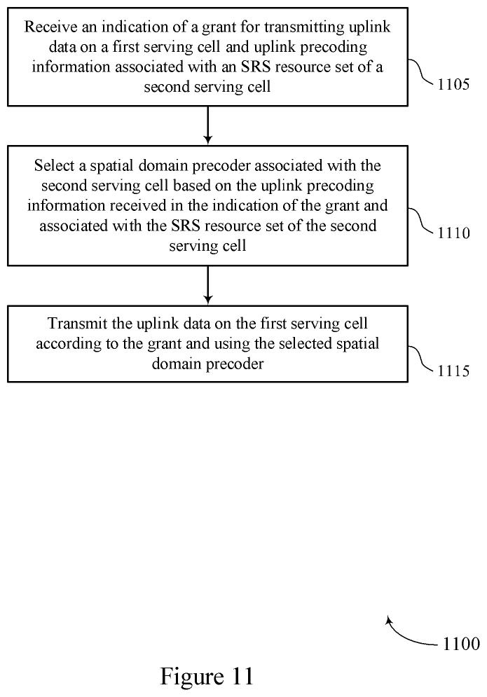

FIG. 11 shows a flowchart illustrating an example method 1100 that supports spatial domain precoders for serving cells in accordance with one or more aspects of the present disclosure. The operations of the method 1100 may be implemented by a device or its components as described herein. For example, the operations of the method 1100 may be performed by a device as described with reference to FIGS. 1-8. In some implementations, a device may execute a set of instructions to control the functional elements of the device to perform the described functions. Additionally, or alternatively, the device may perform aspects of the described functions using special-purpose hardware.

At 1105, the method may include receiving an indication of a grant for transmitting uplink data on a first serving cell and uplink precoding information associated with an SRS resource set of a second serving cell. The operations of 1105 may be performed in accordance with examples as disclosed herein.

At 1110, the method may include selecting a spatial domain precoder associated with the second serving cell based on the uplink precoding information received in the indication of the grant and associated with the SRS resource set of the second serving cell. The operations of 1110 may be performed in accordance with examples as disclosed herein.

At 1115, the method may include transmitting the uplink data on the first serving cell according to the grant and using the selected spatial domain precoder. The operations of 1115 may be performed in accordance with examples as disclosed herein.

The following provides an overview of some aspects of the present disclosure:
Aspect 1: A method for wireless communication at a device, including: receiving a control message indicating an SRS resource on a first serving cell and spatial relation information for the SRS resource, where the spatial relation information associates the SRS resource with a downlink reference signal on a second serving cell; selecting a first spatial domain precoder for transmitting an SRS according to a second spatial domain precoder associated with the downlink reference signal on the second serving cell; and transmitting the SRS via the SRS resource on the first serving cell using the first spatial domain precoder.
Aspect 2: The method of aspect 1, further including: transmitting UE capability information indicating a time interval between receiving the control message indicating the SRS resource and transmitting the SRS.
Aspect 3: The method of any of aspects 1 or 2, where selecting the first spatial domain precoder includes: applying an ML function to the second spatial domain precoder to obtain the first spatial domain precoder.
Aspect 4: The method of aspect 3, further including: receiving an indication of the ML function, where applying the ML function to the second spatial domain precoder is in accordance with receiving the indication of the ML function.
Aspect 5: The method of any of aspects 3 or 4, further including: transmitting an indication of the ML function applied to the second spatial domain precoder to obtain the first spatial domain precoder.
Aspect 6: The method of any of aspects 1-5, where the SRS resource is associated with an SRS resource set including a non-codebook SRS usage.
Aspect 7: The method of any of aspects 1-6, where selecting the first spatial domain precoder is further according to a difference between a first range of frequencies associated with the first serving cell and a second range of frequencies associated with the second serving cell.
Aspect 8: The method of any of aspects 1-7, where selecting the first spatial domain precoder is in response to receiving the control message indicating the SRS resource on the first serving cell when the reference signal is associated with the second serving cell.
Aspect 9: The method of any of aspects 1-8, where the control message includes an RRC message.
Aspect 10: An apparatus for wireless communication at a device, including: an interface configured to: obtain a control message indicating an SRS resource on a first serving cell and spatial relation information for the SRS resource, where the spatial relation information associates the SRS resource with a downlink reference signal on a second serving cell; and a processing system configured to: select a first spatial domain precoder for transmitting an SRS according to a second spatial domain precoder associated with the downlink reference signal on the second serving cell; where the interface is further configured to: output the SRS for transmission via the SRS resource on the first serving cell using the first spatial domain precoder.
Aspect 11: The apparatus of aspect 10, where the interface is further configured to output UE capability information for transmission, the UE capability information indicating a time interval between receiving the control message indicating the SRS resource and transmitting the SRS.
Aspect 12: The apparatus of any of aspects 10 or 11, where the processing system is further configured to apply an ML function to the second spatial domain precoder to obtain the first spatial domain precoder.
Aspect 13: The apparatus of aspect 12, where the interface is further configured to obtain an indication of the ML function, applying the ML function to the second spatial domain precoder is in accordance with obtaining the indication of the ML function.
Aspect 14: The apparatus of any of aspects 12 or 13, where the interface is further configured to output for transmission an indication of the ML function applied to the second spatial domain precoder to obtain the first spatial domain precoder.
Aspect 15: The apparatus of any of aspects 10-14, where the SRS resource is associated with an SRS resource set including a non-codebook SRS usage.
Aspect 16: The apparatus of any of aspects 10-15, where selecting the first spatial domain precoder is further according to a difference between a first range of frequencies associated with the first serving cell and a second range of frequencies associated with the second serving cell.
Aspect 17: The apparatus of any of aspects 10-16, where selecting the first spatial domain precoder is in response to obtaining the control message indicating the SRS resource on the first serving cell when the reference signal is associated with the second serving cell.
Aspect 18: The apparatus of any of aspects 10-17, where the control message includes an RRC message.
Aspect 19: An apparatus for wireless communication at a device, including: a processor; memory coupled with the processor; and instructions stored in the memory and executable by the processor to cause the apparatus to: receive a control message indicating an SRS resource on a first serving cell and spatial relation information for the SRS resource, where the spatial relation information associates the SRS resource with a downlink reference signal on a second serving cell; select a first spatial domain precoder for transmitting an SRS according to a second spatial domain precoder associated with the downlink reference signal on the second serving cell; and transmit the SRS via the SRS resource on the first serving cell using the first spatial domain precoder.
Aspect 20: The apparatus of aspect 19, where the instructions are further executable by the processor to cause the apparatus to: transmit UE capability information indicating a time interval between receiving the control message indicating the SRS resource and transmitting the SRS.
Aspect 21: The apparatus of any of aspects 19 or 20, where the instructions to select the first spatial domain precoder are executable by the processor to cause the apparatus to: apply an ML function to the second spatial domain precoder to obtain the first spatial domain precoder.
Aspect 22: The apparatus of aspect 21, where the instructions are further executable by the processor to cause the apparatus to: receive an indication of the ML function, where applying the ML function to the second spatial domain precoder is in accordance with receiving the indication of the ML function.
Aspect 23: The apparatus of any of aspects 21 or 22, where the instructions are further executable by the processor to cause the apparatus to: transmit an indication of the ML function applied to the second spatial domain precoder to obtain the first spatial domain precoder.
Aspect 24: The apparatus of any of aspects 19-23, where the SRS resource is associated with an SRS resource set including a non-codebook SRS usage.
Aspect 25: The apparatus of any of aspects 19-24, where selecting the first spatial domain precoder is further according to a difference between a first range of frequencies associated with the first serving cell and a second range of frequencies associated with the second serving cell.
Aspect 26: The apparatus of any of aspects 19-25, where selecting the first spatial domain precoder is in response to receiving the control message indicating the SRS resource on the first serving cell when the reference signal is associated with the second serving cell.
Aspect 27: The apparatus of any of aspects 19-26, where the control message includes an RRC message.
Aspect 28: An apparatus for wireless communication at a device, including: means for receiving a control message indicating an SRS resource on a first serving cell and spatial relation information for the SRS resource, where the spatial relation information associates the SRS resource with a downlink reference signal on a second serving cell; means for selecting a first spatial domain precoder for transmitting an SRS according to a second spatial domain precoder associated with the downlink reference signal on the second serving cell; and means for transmitting the SRS via the SRS resource on the first serving cell using the first spatial domain precoder.
Aspect 29: The apparatus of aspect 28, further including: means for transmitting UE capability information indicating a time interval between receiving the control message indicating the SRS resource and transmitting the SRS.
Aspect 30: The apparatus of any of aspects 28 or 29, where the means for selecting the first spatial domain precoder include: means for applying an ML function to the second spatial domain precoder to obtain the first spatial domain precoder.
Aspect 31: The apparatus of aspect 30, further including: means for receiving an indication of the ML function, where applying the ML function to the second spatial domain precoder is in accordance with receiving the indication of the ML function.
Aspect 32: The apparatus of any of aspects 30 or 31, further including: means for transmitting an indication of the ML function applied to the second spatial domain precoder to obtain the first spatial domain precoder.
Aspect 33: The apparatus of any of aspects 28-32, where the SRS resource is associated with an SRS resource set including a non-codebook SRS usage.
Aspect 34: The apparatus of any of aspects 28-33, where selecting the first spatial domain precoder is further according to a difference between a first range of frequencies associated with the first serving cell and a second range of frequencies associated with the second serving cell.
Aspect 35: The apparatus of any of aspects 28-34, where selecting the first spatial domain precoder is in response to receiving the control message indicating the SRS resource on the first serving cell when the reference signal is associated with the second serving cell.
Aspect 36: The apparatus of any of aspects 28-35, where the control message includes an RRC message.
Aspect 37: A non-transitory computer-readable medium storing code for wireless communication at a device, the code including instructions executable by a processor to: receive a control message indicating an SRS resource on a first serving cell and spatial relation information for the SRS resource, where the spatial relation information associates the SRS resource with a downlink reference signal on a second serving cell; select a first spatial domain precoder for transmitting an SRS according to a second spatial domain precoder associated with the downlink reference signal on the second serving cell; and transmit the SRS via the SRS resource on the first serving cell using the first spatial domain precoder.
Aspect 38: The non-transitory computer-readable medium of aspect 37, where the instructions are further executable by the processor to: transmit UE capability information indicating a time interval between receiving the control message indicating the SRS resource and transmitting the SRS.
Aspect 39: The non-transitory computer-readable medium of any of aspects 37 or 38, where the instructions to select the first spatial domain precoder are executable by the processor to: apply an ML function to the second spatial domain precoder to obtain the first spatial domain precoder.
Aspect 40: The non-transitory computer-readable medium of aspect 39, where the instructions are further executable by the processor to: receive an indication of the ML function, where applying the ML function to the second spatial domain precoder is in accordance with receiving the indication of the ML function.
Aspect 41: The non-transitory computer-readable medium of any of aspects 39 or 40, where the instructions are further executable by the processor to: transmit an indication of the ML function applied to the second spatial domain precoder to obtain the first spatial domain precoder.
Aspect 42: The non-transitory computer-readable medium of any of aspects 37-41, where the SRS resource is associated with an SRS resource set including a non-codebook SRS usage.
Aspect 43: The non-transitory computer-readable medium of any of aspects 37-42, where selecting the first spatial domain precoder is further according to a difference between a first range of frequencies associated with the first serving cell and a second range of frequencies associated with the second serving cell.
Aspect 44: The non-transitory computer-readable medium of any of aspects 37-43, where selecting the first spatial domain precoder is in response to receiving the control message indicating the SRS resource on the first serving cell when the reference signal is associated with the second serving cell.
Aspect 45: The non-transitory computer-readable medium of any of aspects 37-44, where the control message includes an RRC message.
Aspect 46: A method for wireless communication at a device, including: receiving a control message indicating a configuration of an SRS resource set for transmitting an SRS on a first serving cell and indicating spatial relation information associating the SRS resource set with a downlink reference signal on a second serving cell; monitoring the second serving cell for the downlink reference signal according to the spatial relation information; selecting a spatial domain precoder for transmitting the SRS over the SRS resource set on the first serving cell according to the control message and the monitoring; and transmitting the SRS over the SRS resource set on the first serving cell using the selected spatial domain precoder.
Aspect 47: The method of aspect 46, where the spatial relation information associates the SRS resource set with a set of multiple downlink reference signals on a set of one or more serving cells including the second serving cell, the method further including: receiving an indication that the downlink reference signal on the second serving cell is selected from the set of multiple downlink reference signals for the SRS resource set.
Aspect 48: The method of aspect 47, where receiving the indication that the downlink reference signal on the second serving cell is selected from the set of multiple downlink reference signals for the SRS resource set includes one of: receiving a SRS request field of a DCI indicating the downlink reference signal on the second serving cell for SRS resource set, where the SRS is aperiodic; or receiving a MAC-CE activating the SRS resource set for transmitting the SRS and indicating the downlink reference signal on the second serving cell, where the SRS is semipersistent.
Aspect 49: The method of any of aspects 46-48, where the SRS is periodic and the control message includes an identifier of the second serving cell.
Aspect 50: The method of any of aspects 46-49, where the SRS is semipersistent and the control message includes a set of multiple identifiers corresponding to a set of multiple serving cells, the set of multiple serving cells including the second serving cell, the method further including: receiving a MAC-CE activating the SRS resource set and activating the second serving cell, where monitoring the second serving cell for the downlink reference signal is based on receiving the MAC-CE.
Aspect 51: The method of any of aspects 46-50, where selecting the spatial domain precoder includes: applying an ML function to the spatial relation information to obtain the spatial domain precoder.
Aspect 52: The method of aspect 51, further including: receiving an indication of the ML function, where applying the ML function to the spatial relation information is in accordance with receiving the indication of the ML function.
Aspect 53: The method of any of aspects 46-52, further including: transmitting UE capability information indicating a time interval between receiving the control message indicating the SRS resource set and transmitting the SRS.
Aspect 54: The method of any of aspects 46-53, where the SRS resource set is associated with a non-codebook SRS usage.
Aspect 55: The method of any of aspects 46-54, where the first serving cell is associated with a first range of frequencies and the second serving cell is associated with a second range of frequencies different from the first range of frequencies.
Aspect 56: An apparatus for wireless communication at a device, including: an interface configured to: obtain a control message indicating a configuration of an SRS resource set for transmitting an SRS on a first serving cell and indicating spatial relation information associating the SRS resource set with a downlink reference signal on a second serving cell; and a processing system configured to: monitor the second serving cell for the downlink reference signal according to the spatial relation information, and select a spatial domain precoder for transmitting the SRS over the SRS resource set on the first serving cell according to the control message and the monitoring; and where the interface is further configured to: output the SRS for transmission over the SRS resource set on the first serving cell using the selected spatial domain precoder.
Aspect 57: The apparatus of aspect 56, where the spatial relation information associates the SRS resource set with a set of multiple downlink reference signals on a set of one or more serving cells including the second serving cell, and the interface is further configured to obtain an indication that the downlink reference signal on the second serving cell is selected from the set of multiple downlink reference signals for the SRS resource set.
Aspect 58: The apparatus of aspect 57, where the interface is further configured to: obtain an SRS request field of a DCI indicating the downlink reference signal on the second serving cell for SRS resource set, where the SRS is aperiodic; or obtain a MAC-CE activating the SRS resource set for transmitting the SRS and indicating the downlink reference signal on the second serving cell, where the SRS is semipersistent.
Aspect 59: The apparatus of any of aspects 56-58, where the SRS is periodic and the control message includes an identifier of the second serving cell.
Aspect 60: The apparatus of any of aspects 56-59, where the SRS is semipersistent and the control message includes a set of multiple identifiers corresponding to a set of multiple serving cells, and the interface is further configured to obtain a MAC-CE activating the SRS resource set and activating the second serving cell, monitoring the second serving cell for the downlink reference signal is based on obtaining the MAC-CE.
Aspect 61: The apparatus of any of aspects 56-60, where the processing system is further configured to apply an ML function to the spatial relation information to obtain the spatial domain precoder.
Aspect 62: The apparatus of aspect 61, where the interface is further configured to obtain an indication of the ML function, applying the ML function to the spatial relation information is in accordance with obtaining the indication of the ML function.
Aspect 63: The apparatus of any of aspects 56-62, where the interface is further configured to output UE capability information for transmission, the UE capability information indicating a time interval between receiving the control message indicating the SRS resource set and transmitting the SRS.
Aspect 64: The apparatus of any of aspects 56-63, where the SRS resource set is associated with a non-codebook SRS usage.
Aspect 65: The apparatus of any of aspects 56-64, where the first serving cell is associated with a first range of frequencies and the second serving cell is associated with a second range of frequencies different from the first range of frequencies.
Aspect 66: An apparatus for wireless communication at a device, including: a processor; memory coupled with the processor; and instructions stored in the memory and executable by the processor to cause the apparatus to: receive a control message indicating a configuration of an SRS resource set for transmitting an SRS on a first serving cell and indicating spatial relation information associating the SRS resource set with a downlink reference signal on a second serving cell; monitor the second serving cell for the downlink reference signal according to the spatial relation information; select a spatial domain precoder for transmitting the SRS over the SRS resource set on the first serving cell according to the control message and the monitoring; and transmit the SRS over the SRS resource set on the first serving cell using the selected spatial domain precoder.
Aspect 67: The apparatus of aspect 66, where the spatial relation information associates the SRS resource set with a set of multiple downlink reference signals on a set of one or more serving cells including the second serving cell, and the instructions are further executable by the processor to cause the apparatus to: receive an indication that the downlink reference signal on the second serving cell is selected from the set of multiple downlink reference signals for the SRS resource set.
Aspect 68: The apparatus of aspect 67, where the instructions to are executable by the processor to cause the apparatus to: receive a SRS request field of a DCI indicating the downlink reference signal on the second serving cell for SRS resource set, where the SRS is aperiodic; or receive a MAC-CE activating the SRS resource set for transmitting the SRS and indicating the downlink reference signal on the second serving cell, where the SRS is semipersistent.
Aspect 69: The apparatus of any of aspects 66-68, where the SRS is periodic and the control message includes an identifier of the second serving cell.
Aspect 70: The apparatus of any of aspects 66-69, where the SRS is semipersistent and the control message includes a set of multiple identifiers corresponding to a set of multiple serving cells, and the instructions are further executable by the processor to cause the apparatus to: receive a MAC-CE activating the SRS resource set and activating the second serving cell, where monitoring the second serving cell for the downlink reference signal is based on receiving the MAC-CE.
Aspect 71: The apparatus of any of aspects 66-70, where the instructions to select the spatial domain precoder are executable by the processor to cause the apparatus to: apply an ML function to the spatial relation information to obtain the spatial domain precoder.
Aspect 72: The apparatus of aspect 71, where the instructions are further executable by the processor to cause the apparatus to: receive an indication of the ML function, where applying the ML function to the spatial relation information is in accordance with receiving the indication of the ML function.
Aspect 73: The apparatus of any of aspects 66-72, where the instructions are further executable by the processor to cause the apparatus to: transmit UE capability information indicating a time interval between receiving the control message indicating the SRS resource set and transmitting the SRS.
Aspect 74: The apparatus of any of aspects 66-73, where the SRS resource set is associated with a non-codebook SRS usage.
Aspect 75: The apparatus of any of aspects 66-74, where the first serving cell is associated with a first range of frequencies and the second serving cell is associated with a second range of frequencies different from the first range of frequencies.
Aspect 76: An apparatus for wireless communication at a device, including: means for receiving a control message indicating a configuration of an SRS resource set for transmitting an SRS on a first serving cell and indicating spatial relation information associating the SRS resource set with a downlink reference signal on a second serving cell; means for monitoring the second serving cell for the downlink reference signal according to the spatial relation information; means for selecting a spatial domain precoder for transmitting the SRS over the SRS resource set on the first serving cell according to the control message and the monitoring; and means for transmitting the SRS over the SRS resource set on the first serving cell using the selected spatial domain precoder.
Aspect 77: The apparatus of aspect 76, where the spatial relation information associates the SRS resource set with a set of multiple downlink reference signals on a set of one or more serving cells including the second serving cell, the apparatus further including: means for receiving an indication that the downlink reference signal on the second serving cell is selected from the set of multiple downlink reference signals for the SRS resource set.
Aspect 78: The apparatus of aspect 77, where the means for include: means for receiving a SRS request field of a DCI indicating the downlink reference signal on the second serving cell for SRS resource set, where the SRS is aperiodic; or means for receiving a MAC-CE activating the SRS resource set for transmitting the SRS and indicating the downlink reference signal on the second serving cell, where the SRS is semipersistent.
Aspect 79: The apparatus of any of aspects 76-78, where the SRS is periodic and the control message includes an identifier of the second serving cell.
Aspect 80: The apparatus of any of aspects 76-79, where the SRS is semipersistent and the control message includes a set of multiple identifiers corresponding to a set of multiple serving cells, the apparatus further including: means for receiving a MAC-CE activating the SRS resource set and activating the second serving cell, where monitoring the second serving cell for the downlink reference signal is based on receiving the MAC-CE.
Aspect 81: The apparatus of any of aspects 76-80, where the means for selecting the spatial domain precoder include: means for applying an ML function to the spatial relation information to obtain the spatial domain precoder.
Aspect 82: The apparatus of aspect 81, further including: means for receiving an indication of the ML function, where applying the ML function to the spatial relation information is in accordance with receiving the indication of the ML function.
Aspect 83: The apparatus of any of aspects 76-82, further including: means for transmitting UE capability information indicating a time interval between receiving the control message indicating the SRS resource set and transmitting the SRS.
Aspect 84: The apparatus of any of aspects 76-83, where the SRS resource set is associated with a non-codebook SRS usage.
Aspect 85: The apparatus of any of aspects 76-84, where the first serving cell is associated with a first range of frequencies and the second serving cell is associated with a second range of frequencies different from the first range of frequencies.
Aspect 86: A non-transitory computer-readable medium storing code for wireless communication at a device, the code including instructions executable by a processor to: receive a control message indicating a configuration of an SRS resource set for transmitting an SRS on a first serving cell and indicating spatial relation information associating the SRS resource set with a downlink reference signal on a second serving cell; monitor the second serving cell for the downlink reference signal according to the spatial relation information; select a spatial domain precoder for transmitting the SRS over the SRS resource set on the first serving cell according to the control message and the monitoring; and transmit the SRS over the SRS resource set on the first serving cell using the selected spatial domain precoder.
Aspect 87: The non-transitory computer-readable medium of aspect 86, where the spatial relation information associates the SRS resource set with a set of multiple downlink reference signals on a set of one or more serving cells including the second serving cell, and the instructions are further executable by the processor to: receive an indication that the downlink reference signal on the second serving cell is selected from the set of multiple downlink reference signals for the SRS resource set.
Aspect 88: The non-transitory computer-readable medium of aspect 87, where the instructions to are executable by the processor to: receive a SRS request field of a DCI indicating the downlink reference signal on the second serving cell for SRS resource set, where the SRS is aperiodic; or receive a MAC-CE activating the SRS resource set for transmitting the SRS and indicating the downlink reference signal on the second serving cell, where the SRS is semipersistent.
Aspect 89: The non-transitory computer-readable medium of any of aspects 86-88, where the SRS is periodic and the control message includes an identifier of the second serving cell.
Aspect 90: The non-transitory computer-readable medium of any of aspects 86-89, where the SRS is semipersistent and the control message includes a set of multiple identifiers corresponding to a set of multiple serving cells, and the instructions are further executable by the processor to: receive a MAC-CE activating the SRS resource set and activating the second serving cell, where monitoring the second serving cell for the downlink reference signal is based on receiving the MAC-CE.
Aspect 91: The non-transitory computer-readable medium of any of aspects 86-90, where the instructions to select the spatial domain precoder are executable by the processor to: apply an ML function to the spatial relation information to obtain the spatial domain precoder.
Aspect 92: The non-transitory computer-readable medium of aspect 91, where the instructions are further executable by the processor to: receive an indication of the ML function, where applying the ML function to the spatial relation information is in accordance with receiving the indication of the ML function.
Aspect 93: The non-transitory computer-readable medium of any of aspects 86-92, where the instructions are further executable by the processor to: transmit UE capability information indicating a time interval between receiving the control message indicating the SRS resource set and transmitting the SRS.
Aspect 94: The non-transitory computer-readable medium of any of aspects 86-93, where the SRS resource set is associated with a non-codebook SRS usage.
Aspect 95: The non-transitory computer-readable medium of any of aspects 86-94, where the first serving cell is associated with a first range of frequencies and the second serving cell is associated with a second range of frequencies different from the first range of frequencies.
Aspect 96: A method for wireless communication at a device, including: receiving an indication of a grant for transmitting uplink data on a first serving cell and uplink precoding information associated with an SRS resource set of a second serving cell; selecting a spatial domain precoder associated with the second serving cell based on the uplink precoding information received in the indication of the grant and associated with the SRS resource set of the second serving cell; and transmitting the uplink data on the first serving cell according to the grant and using the selected spatial domain precoder.
Aspect 97: The method of aspect 96, further including: receiving an indication of a channel on the second serving cell corresponding to the SRS resource set of the second serving cell, an angle of arrival associated with the channel on the second serving cell corresponding to the SRS resource set of the second serving cell, an angle of departure associated with the channel on the second serving cell corresponding to the SRS resource set of the second serving cell, or a combination thereof, where selecting the spatial domain precoder is in accordance with the channel on the second serving cell corresponding to the SRS resource set of the second serving cell, the angle of arrival associated with the channel on the second serving cell corresponding to the SRS resource set of the second serving cell, the angle of departure associated with the channel on the second serving cell corresponding to the SRS resource set of the second serving cell, or the combination thereof.
Aspect 98: The method of any of aspects 96 or 97, where the uplink precoding information further indicates one or more SRS resource sets associated with the first serving cell.
Aspect 99: The method of any of aspects 96-98, further including: receiving an indication of a channel on the first serving cell corresponding to the SRS resource set of the second serving cell, an angle of arrival associated with the channel on the first serving cell corresponding to the SRS resource set of the second serving cell, an angle of departure associated with the channel on the first serving cell corresponding to the SRS resource set of the second serving cell, or a combination thereof, where selecting the spatial domain precoder is in accordance with the channel on the first serving cell corresponding to the SRS resource set of the second serving cell, the angle of arrival associated with channel on the first serving cell corresponding to the SRS resource set of the second serving cell, the angle of departure associated with the channel on the first serving cell corresponding to the SRS resource set of the second serving cell, or the combination thereof.
Aspect 100: The method of any of aspects 96-99, where selecting the spatial domain precoder includes: applying an ML function to the uplink precoding information to obtain the spatial domain precoder.
Aspect 101: The method of aspect 100, further including: receiving an indication of the ML function, where applying the machine learning function to the uplink precoding information is in accordance with receiving the indication of the ML function.
Aspect 102: The method of any of aspects 96-101, further including: transmitting an indication of a maximum rank corresponding to the uplink precoding information, one or more coherence types associated with the uplink precoding information, or both, where the spatial domain precoder is selected in accordance with the maximum rank corresponding to the uplink precoding information, the one or more coherence types associated with the uplink precoding information, or both; where transmitting the uplink data is in accordance with the indication of the maximum rank.
Aspect 103: The method of any of aspects 96-102, where transmitting the uplink data on the first serving cell using the spatial domain precoder is in response to one or more of the indication of the grant including an identifier associated with the second serving cell, the indication of the grant being received via the second serving cell, a difference in frequency resources between the first serving cell and the second serving cell, or a combination thereof.
Aspect 104: The method of any of aspects 96-103, further including: transmitting a UE capability message indicating a time interval between receiving signaling indicating the grant and transmitting the uplink data using the selected spatial domain precoder.
Aspect 105: The method of any of aspects 96-104, further including: receiving signaling indicating that the SRS resource set of the second serving cell is associated with cross frequency range precoding.
Aspect 106: An apparatus for wireless communication at a device, including: an interface configured to: obtain an indication of a grant for transmitting uplink data on a first serving cell and uplink precoding information associated with an SRS resource set of a second serving cell; and a processing system configured to: select a spatial domain precoder associated with the second serving cell based on the uplink precoding information obtained in the indication of the grant and associated with the SRS resource set of the second serving cell; where the interface is further configured to: output the uplink data for transmission on the first serving cell according to the grant and using the selected spatial domain precoder.
Aspect 107: The apparatus of aspect 106, where the interface is further configured to obtain an indication of a channel on the second serving cell corresponding to the SRS resource set of the second serving cell, an angle of arrival associated with the channel on the second serving cell corresponding to the SRS resource set of the second serving cell, an angle of departure associated with the channel on the second serving cell corresponding to the SRS resource set of the second serving cell, or a combination thereof, selecting the spatial domain precoder is in accordance with the channel on the second serving cell corresponding to the SRS resource set of the second serving cell, the angle of arrival associated with the channel on the second serving cell corresponding to the SRS resource set of the second serving cell, the angle of departure associated with the channel on the second serving cell corresponding to the SRS resource set of the second serving cell, or the combination thereof.
Aspect 108: The apparatus of any of aspects 106 or 107, where the uplink precoding information further indicates one or more SRS resource sets associated with the first serving cell.
Aspect 109: The apparatus of any of aspects 106-108, where the interface is further configured to obtain an indication of a channel on the first serving cell corresponding to the SRS resource set of the second serving cell, an angle of arrival associated with the channel on the first serving cell corresponding to the SRS resource set of the second serving cell, an angle of departure associated with the channel on the first serving cell corresponding to the SRS resource set of the second serving cell, or a combination thereof, selecting the spatial domain precoder is in accordance with the channel on the first serving cell corresponding to the SRS resource set of the second serving cell, the angle of arrival associated with channel on the first serving cell corresponding to the SRS resource set of the second serving cell, the angle of departure associated with the channel on the first serving cell corresponding to the SRS resource set of the second serving cell, or the combination thereof.
Aspect 110: The apparatus of any of aspects 106-109, where the processing system is further configured to apply an ML function to the uplink precoding information to obtain the spatial domain precoder.
Aspect 111: The apparatus of aspect 110, where the interface is further configured to obtain an indication of the ML function, applying the ML function to the uplink precoding information is in accordance with obtaining the indication of the ML function.
Aspect 112: The apparatus of any of aspects 106-111, where the interface is further configured to output for transmission an indication of a maximum rank corresponding to the uplink precoding information, one or more coherence types associated with the uplink precoding information, or both, the spatial domain precoder is selected in accordance with the maximum rank corresponding to the uplink precoding information, the one or more coherence types associated with the uplink precoding information, or both; outputting the uplink data for transmission is in accordance with the indication of the maximum rank.
Aspect 113: The apparatus of any of aspects 106-112, where the indication of the grant includes an identifier associated with the second serving cell, the indication of the grant being obtained via the second serving cell, a difference in frequency resources between the first serving cell and the second serving cell, or a combination thereof.
Aspect 114: The apparatus of any of aspects 106-113, where the interface is further configured to output a UE capability message indicating a time interval between obtaining signaling indicating the grant and outputting the uplink data using the selected spatial domain precoder.
Aspect 115: The apparatus of any of aspects 106-114, where the interface is further configured to obtain signaling indicating that the SRS resource set of the second serving cell is associated with cross frequency range precoding.
Aspect 116: An apparatus for wireless communication at a device, including: a processor; memory coupled with the processor; and instructions stored in the memory and executable by the processor to cause the apparatus to: receive an indication of a grant for transmitting uplink data on a first serving cell and uplink precoding information associated with an SRS resource set of a second serving cell; select a spatial domain precoder associated with the second serving cell based on the uplink precoding information received in the indication of the grant and associated with the SRS resource set of the second serving cell; and transmit the uplink data on the first serving cell according to the grant and using the selected spatial domain precoder.
Aspect 117: The apparatus of aspect 116, where the instructions are further executable by the processor to cause the apparatus to: receive an indication of a channel on the second serving cell corresponding to the SRS resource set of the second serving cell, an angle of arrival associated with the channel on the second serving cell corresponding to the SRS resource set of the second serving cell, an angle of departure associated with the channel on the second serving cell corresponding to the SRS resource set of the second serving cell, or a combination thereof, where selecting the spatial domain precoder is in accordance with the channel on the second serving cell corresponding to the SRS resource set of the second serving cell, the angle of arrival associated with the channel on the second serving cell corresponding to the SRS resource set of the second serving cell, the angle of departure associated with the channel on the second serving cell corresponding to the SRS resource set of the second serving cell, or the combination thereof.
Aspect 118: The apparatus of any of aspects 116 or 117, where the uplink precoding information further indicates one or more SRS resource sets associated with the first serving cell.
Aspect 119: The apparatus of any of aspects 116-118, where the instructions are further executable by the processor to cause the apparatus to: receive an indication of a channel on the first serving cell corresponding to the SRS resource set of the second serving cell, an angle of arrival associated with the channel on the first serving cell corresponding to the SRS resource set of the second serving cell, an angle of departure associated with the channel on the first serving cell corresponding to the SRS resource set of the second serving cell, or a combination thereof, where selecting the spatial domain precoder is in accordance with the channel on the first serving cell corresponding to the SRS resource set of the second serving cell, the angle of arrival associated with channel on the first serving cell corresponding to the SRS resource set of the second serving cell, the angle of departure associated with the channel on the first serving cell corresponding to the SRS resource set of the second serving cell, or the combination thereof.
Aspect 120: The apparatus of any of aspects 116-119, where the instructions to select the spatial domain precoder are executable by the processor to cause the apparatus to: apply an ML function to the uplink precoding information to obtain the spatial domain precoder.
Aspect 121: The apparatus of aspect 120, where the instructions are further executable by the processor to cause the apparatus to: receive an indication of the ML function, where applying the machine learning function to the uplink precoding information is in accordance with receiving the indication of the ML function.
Aspect 122: The apparatus of any of aspects 116-121, where the instructions are further executable by the processor to cause the apparatus to: transmit an indication of a maximum rank corresponding to the uplink precoding information, one or more coherence types associated with the uplink precoding information, or both, where the spatial domain precoder is selected in accordance with the maximum rank corresponding to the uplink precoding information, the one or more coherence types associated with the uplink precoding information, or both; where transmitting the uplink data is in accordance with the indication of the maximum rank.
Aspect 123: The apparatus of any of aspects 116-122, where the indication of the grant including an identifier associated with the second serving cell, the indication of the grant being received via the second serving cell, a difference in frequency resources between the first serving cell and the second serving cell, or a combination thereof.
Aspect 124: The apparatus of any of aspects 116-123, where the instructions are further executable by the processor to cause the apparatus to: transmit a UE capability message indicating a time interval between receiving signaling indicating the grant and transmitting the uplink data using the selected spatial domain precoder.
Aspect 125: The apparatus of any of aspects 116-124, where the instructions are further executable by the processor to cause the apparatus to: receive signaling indicating that the SRS resource set of the second serving cell is associated with cross frequency range precoding.
Aspect 126: An apparatus for wireless communication at a device, including: means for receiving an indication of a grant for transmitting uplink data on a first serving cell and uplink precoding information associated with an SRS resource set of a second serving cell; means for selecting a spatial domain precoder associated with the second serving cell based on the uplink precoding information received in the indication of the grant and associated with the SRS resource set of the second serving cell; and means for transmitting the uplink data on the first serving cell according to the grant and using the selected spatial domain precoder.
Aspect 127: The apparatus of aspect 126, further including: means for receiving an indication of a channel on the second serving cell corresponding to the SRS resource set of the second serving cell, an angle of arrival associated with the channel on the second serving cell corresponding to the SRS resource set of the second serving cell, an angle of departure associated with the channel on the second serving cell corresponding to the SRS resource set of the second serving cell, or a combination thereof, where selecting the spatial domain precoder is in accordance with the channel on the second serving cell corresponding to the SRS resource set of the second serving cell, the angle of arrival associated with the channel on the second serving cell corresponding to the SRS resource set of the second serving cell, the angle of departure associated with the channel on the second serving cell corresponding to the SRS resource set of the second serving cell, or the combination thereof.
Aspect 128: The apparatus of any of aspects 126 or 127, where the uplink precoding information further indicates one or more SRS resource sets associated with the first serving cell.
Aspect 129: The apparatus of any of aspects 126-128, further including: means for receiving an indication of a channel on the first serving cell corresponding to the SRS resource set of the second serving cell, an angle of arrival associated with the channel on the first serving cell corresponding to the SRS resource set of the second serving cell, an angle of departure associated with the channel on the first serving cell corresponding to the SRS resource set of the second serving cell, or a combination thereof, where selecting the spatial domain precoder is in accordance with the channel on the first serving cell corresponding to the SRS resource set of the second serving cell, the angle of arrival associated with channel on the first serving cell corresponding to the SRS resource set of the second serving cell, the angle of departure associated with the channel on the first serving cell corresponding to the SRS resource set of the second serving cell, or the combination thereof.
Aspect 130: The apparatus of any of aspects 126-129, where the means for selecting the spatial domain precoder include: means for applying an ML function to the uplink precoding information to obtain the spatial domain precoder.
Aspect 131: The apparatus of aspect 130, further including: means for receiving an indication of the ML function, where applying the machine learning function to the uplink precoding information is in accordance with receiving the indication of the ML function.
Aspect 132: The apparatus of any of aspects 126-131, further including: means for transmitting an indication of a maximum rank corresponding to the uplink precoding information, one or more coherence types associated with the uplink precoding information, or both, where the spatial domain precoder is selected in accordance with the maximum rank corresponding to the uplink precoding information, the one or more coherence types associated with the uplink precoding information, or both; where transmitting the uplink data is in accordance with the indication of the maximum rank.
Aspect 133: The apparatus of any of aspects 126-132, where the indication of the grant including an identifier associated with the second serving cell, the indication of the grant being received via the second serving cell, a difference in frequency resources between the first serving cell and the second serving cell, or a combination thereof.
Aspect 134: The apparatus of any of aspects 126-133, further including: means for transmitting a UE capability message indicating a time interval between receiving signaling indicating the grant and transmitting the uplink data using the selected spatial domain precoder.
Aspect 135: The apparatus of any of aspects 126-134, further including: means for receiving signaling indicating that the SRS resource set of the second serving cell is associated with cross frequency range precoding.
Aspect 136: A non-transitory computer-readable medium storing code for wireless communication at a device, the code including instructions executable by a processor to: receive an indication of a grant for transmitting uplink data on a first serving cell and uplink precoding information associated with an SRS resource set of a second serving cell; select a spatial domain precoder associated with the second serving cell based on the uplink precoding information received in the indication of the grant and associated with the SRS resource set of the second serving cell; and transmit the uplink data on the first serving cell according to the grant and using the selected spatial domain precoder.
Aspect 137: The non-transitory computer-readable medium of aspect 136, where the instructions are further executable by the processor to: receive an indication of a channel on the second serving cell corresponding to the SRS resource set of the second serving cell, an angle of arrival associated with the channel on the second serving cell corresponding to the SRS resource set of the second serving cell, an angle of departure associated with the channel on the second serving cell corresponding to the SRS resource set of the second serving cell, or a combination thereof, where selecting the spatial domain precoder is in accordance with the channel on the second serving cell corresponding to the SRS resource set of the second serving cell, the angle of arrival associated with the channel on the second serving cell corresponding to the SRS resource set of the second serving cell, the angle of departure associated with the channel on the second serving cell corresponding to the SRS resource set of the second serving cell, or the combination thereof.
Aspect 138: The non-transitory computer-readable medium of any of aspects 136 or 137, where the uplink precoding information further indicates one or more SRS resource sets associated with the first serving cell.
Aspect 139: The non-transitory computer-readable medium of any of aspects 136-138, where the instructions are further executable by the processor to: receive an indication of a channel on the first serving cell corresponding to the SRS resource set of the second serving cell, an angle of arrival associated with the channel on the first serving cell corresponding to the SRS resource set of the second serving cell, an angle of departure associated with the channel on the first serving cell corresponding to the SRS resource set of the second serving cell, or a combination thereof, where selecting the spatial domain precoder is in accordance with the channel on the first serving cell corresponding to the SRS resource set of the second serving cell, the angle of arrival associated with channel on the first serving cell corresponding to the SRS resource set of the second serving cell, the angle of departure associated with the channel on the first serving cell corresponding to the SRS resource set of the second serving cell, or the combination thereof.
Aspect 140: The non-transitory computer-readable medium of any of aspects 136-139, where the instructions to select the spatial domain precoder are executable by the processor to: apply an ML function to the uplink precoding information to obtain the spatial domain precoder.
Aspect 141: The non-transitory computer-readable medium of aspect 140, where the instructions are further executable by the processor to: receive an indication of the ML function, where applying the machine learning function to the uplink precoding information is in accordance with receiving the indication of the ML function.
Aspect 142: The non-transitory computer-readable medium of any of aspects 136-141, where the instructions are further executable by the processor to: transmit an indication of a maximum rank corresponding to the uplink precoding information, one or more coherence types associated with the uplink precoding information, or both, where the spatial domain precoder is selected in accordance with the maximum rank corresponding to the uplink precoding information, the one or more coherence types associated with the uplink precoding information, or both; where transmitting the uplink data is in accordance with the indication of the maximum rank.
Aspect 143: The non-transitory computer-readable medium of any of aspects 136-142, where the indication of the grant including an identifier associated with the second serving cell, the indication of the grant being received via the second serving cell, a difference in frequency resources between the first serving cell and the second serving cell, or a combination thereof.
Aspect 144: The non-transitory computer-readable medium of any of aspects 136-143, where the instructions are further executable by the processor to: transmit a UE capability message indicating a time interval between receiving signaling indicating the grant and transmitting the uplink data using the selected spatial domain precoder.
Aspect 145: The non-transitory computer-readable medium of any of aspects 136-144, where the instructions are further executable by the processor to: receive signaling indicating that the SRS resource set of the second serving cell is associated with cross frequency range precoding.

As used herein, the term “determine” or “determining” encompasses a wide variety of actions and, therefore, “determining” can include calculating, computing, processing, deriving, investigating, looking up (such as via looking up in a table, a database or another data structure), inferring, ascertaining, and the like. Also, “determining” can include receiving (such as receiving information), accessing (such as accessing data in a memory) and the like. Also, “determining” can include resolving, selecting, choosing, establishing and other such similar actions.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, or any processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, such as one or more modules of computer program instructions, encoded on a computer storage media for execution by, or to control the operation of, data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the features disclosed herein.

Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of any device as implemented.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described above as acting in some combinations and even initially claimed as such, one or more features from a claimed combination can be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In some circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, other implementations are within the scope of the following claims. In some implementations, the actions recited in the claims can be performed in a different order and still achieve desirable results.

What is claimed is:

1. An apparatus for wireless communication at a device, comprising:
an interface configured to:
obtain a control message indicating a sounding reference signal (SRS) resource on a first serving cell and spatial relation information for the SRS resource, wherein the spatial relation information associates the SRS resource with a downlink reference signal on a second serving cell; and
a processing system configured to:
select a first spatial domain precoder for transmitting an SRS according to a second spatial domain precoder associated with the downlink reference signal on the second serving cell;
wherein the interface is further configured to:
output the SRS for transmission via the SRS resource on the first serving cell using the first spatial domain precoder.

2. The apparatus of claim 1, wherein the interface is further configured to output user equipment (UE) capability information for transmission, the UE capability information indicating a time interval between receiving the control message indicating the SRS resource and transmitting the SRS.

3. The apparatus of claim 1, wherein the processing system is further configured to apply a machine learning (ML) function to the second spatial domain precoder to obtain the first spatial domain precoder.

4. The apparatus of claim 3, wherein the interface is further configured to obtain an indication of the ML function, wherein applying the ML function to the second spatial domain precoder is in accordance with obtaining the indication of the ML function.

5. The apparatus of claim 3, wherein the interface is further configured to output for transmission an indication of the ML function applied to the second spatial domain precoder to obtain the first spatial domain precoder.

6. The apparatus of claim 1, wherein the SRS resource is associated with an SRS resource set comprising a non-codebook SRS usage.

7. The apparatus of claim 1, wherein selecting the first spatial domain precoder is further according to a difference between a first range of frequencies associated with the first serving cell and a second range of frequencies associated with the second serving cell.

8. The apparatus of claim 1, wherein selecting the first spatial domain precoder is in response to obtaining the control message indicating the SRS resource on the first serving cell when the reference signal is associated with the second serving cell.

9. The apparatus of claim 1, wherein the control message comprises a radio resource control (RRC) message.

10. An apparatus for wireless communication at a device, comprising:
an interface configured to:
obtain a control message indicating a configuration of a sounding reference signal (SRS) resource set for transmitting an SRS on a first serving cell and indicating spatial relation information associating the SRS resource set with a downlink reference signal on a second serving cell; and
a processing system configured to:
monitor the second serving cell for the downlink reference signal according to the spatial relation information, and
select a spatial domain precoder for transmitting the SRS over the SRS resource set on the first serving cell according to the control message and the monitoring; and
wherein the interface is further configured to:
output the SRS for transmission over the SRS resource set on the first serving cell using the selected spatial domain precoder.

11. The apparatus of claim 10, wherein the spatial relation information associates the SRS resource set with a plurality of downlink reference signals on a set of one or more serving cells including the second serving cell, and the interface is further configured to obtain an indication that the downlink reference signal on the second serving cell is selected from the plurality of downlink reference signals for the SRS resource set.

12. The apparatus of claim 11, wherein the interface is further configured to:
obtain an SRS request field of a downlink control information (DCI) indicating the downlink reference signal on the second serving cell for SRS resource set, wherein the SRS is aperiodic; or
obtain a media access control-control element (MAC-CE) activating the SRS resource set for transmitting the SRS and indicating the downlink reference signal on the second serving cell, wherein the SRS is semipersistent.

13. The apparatus of claim 10, wherein the SRS is periodic and the control message comprises an identifier of the second serving cell.

14. The apparatus of claim 10, wherein the SRS is semipersistent and the control message comprises a plurality of identifiers corresponding to a plurality of serving cells, and the interface is further configured to obtain a media access control-control element (MAC-CE) activating the SRS resource set and activating the second serving cell, wherein monitoring the second serving cell for the downlink reference signal is based at least in part on obtaining the MAC-CE.

15. The apparatus of claim 10, wherein the processing system is further configured to apply a machine learning (ML) function to the spatial relation information to obtain the spatial domain precoder.

16. The apparatus of claim 15, wherein the interface is further configured to obtain an indication of the ML function, wherein applying the ML function to the spatial relation information is in accordance with obtaining the indication of the ML function.

17. The apparatus of claim 10, wherein the interface is further configured to output user equipment (UE) capability information for transmission, the UE capability information indicating a time interval between receiving the control message indicating the SRS resource set and transmitting the SRS.

18. The apparatus of claim 10, wherein the SRS resource set is associated with a non-codebook SRS usage.

19. The apparatus of claim 10, wherein the first serving cell is associated with a first range of frequencies and the second serving cell is associated with a second range of frequencies different from the first range of frequencies.

20. An apparatus for wireless communication at a device, comprising:
an interface configured to:
obtain an indication of a grant for transmitting uplink data on a first serving cell and uplink precoding information associated with a sounding reference signal (SRS) resource set of a second serving cell; and
a processing system configured to:
select a spatial domain precoder associated with the second serving cell based at least in part on the uplink precoding information obtained in the indication of the grant and associated with the SRS resource set of the second serving cell;
wherein the interface is further configured to:
output the uplink data for transmission on the first serving cell according to the grant and using the selected spatial domain precoder.

21. The apparatus of claim 20, wherein the interface is further configured to obtain an indication of a channel on the second serving cell corresponding to the SRS resource set of the second serving cell, an angle of arrival associated with the channel on the second serving cell corresponding to the SRS resource set of the second serving cell, an angle of departure associated with the channel on the second serving cell corresponding to the SRS resource set of the second serving cell, or a combination thereof, wherein selecting the spatial domain precoder is in accordance with the channel on the second serving cell corresponding to the SRS resource set of the second serving cell, the angle of arrival associated with the channel on the second serving cell corresponding to the SRS resource set of the second serving cell, the angle of departure associated with the channel on the second serving cell corresponding to the SRS resource set of the second serving cell, or the combination thereof.

22. The apparatus of claim 20, wherein the uplink precoding information further indicates one or more SRS resource sets associated with the first serving cell.

23. The apparatus of claim 20, wherein the interface is further configured to obtain an indication of a channel on the first serving cell corresponding to the SRS resource set of the second serving cell, an angle of arrival associated with the channel on the first serving cell corresponding to the SRS resource set of the second serving cell, an angle of departure associated with the channel on the first serving cell corresponding to the SRS resource set of the second serving cell, or a combination thereof, wherein selecting the spatial domain precoder is in accordance with the channel on the first serving cell corresponding to the SRS resource set of the second serving cell, the angle of arrival associated with channel on the first serving cell corresponding to the SRS resource set of the second serving cell, the angle of departure associated with the channel on the first serving cell corresponding to the SRS resource set of the second serving cell, or the combination thereof.

24. The apparatus of claim 20, wherein the processing system is further configured to apply a machine learning (ML) function to the uplink precoding information to obtain the spatial domain precoder.

25. The apparatus of claim 24, wherein the interface is further configured to obtain an indication of the ML function, wherein applying the ML function to the uplink precoding information is in accordance with obtaining the indication of the ML function.

26. The apparatus of claim 20, wherein the interface is further configured to output for transmission an indication of a maximum rank corresponding to the uplink precoding information, one or more coherence types associated with the uplink precoding information, or both, wherein the spatial domain precoder is selected in accordance with the maximum rank corresponding to the uplink precoding information, the one or more coherence types associated with the uplink precoding information, or both; wherein outputting the uplink data for transmission is in accordance with the indication of the maximum rank.

27. The apparatus of claim 20, wherein the indication of the grant includes an identifier associated with the second serving cell, the indication of the grant being obtained via the second serving cell, a difference in frequency resources between the first serving cell and the second serving cell, or a combination thereof.

28. The apparatus of claim 20, wherein the interface is further configured to output a user equipment (UE) capability message indicating a time interval between obtaining signaling indicating the grant and outputting the uplink data using the selected spatial domain precoder.

29. The apparatus of claim 20, wherein the interface is further configured to obtain signaling indicating that the SRS resource set of the second serving cell is associated with cross frequency range precoding.

30. A method for wireless communication at a device, comprising:
receiving a control message indicating a sounding reference signal (SRS) resource on a first serving cell and spatial relation information for the SRS resource, wherein the spatial relation information associates the SRS resource with a downlink reference signal on a second serving cell;
selecting a first spatial domain precoder for transmitting an SRS according to a second spatial domain precoder associated with the downlink reference signal on the second serving cell; and
transmitting the SRS via the SRS resource on the first serving cell using the first spatial domain precoder.
